(19) United States
(12) Patent Application Publication
(10) Pub. No.: US 2004/0039689 A1
(43) Pub. Date: Feb. 26, 2004

(54) Method and apparatus for managing financial transactions involving multiple counterparties and processing data pertaining thereto

(76) Inventors: Neill Penney, Surrey (GB); David Wright, New York, NY (US); Paul Hasenfus, New York, NY (US)

Correspondence Address: COVINGTON & BURLING, ATTN: PATENT DOCKETING, 1201 PENNSYLVANIA AVENUE, N.W., WASHINGTON, DC, 20004-2401, US

(21) Appl. No.: 10/463,866

(22) Filed: Jun. 18, 2003

Related U.S. Application Data
(60) Provisional application No. 60/389,481, filed on Jun. 19, 2002.
(60) Provisional application No. 60/395,348, filed on Jul. 12, 2002.
(60) Provisional application No. 60/461,145, filed on Apr. 9, 2003.

(51) Int. Cl. G06F 17/60

(52) U.S. Cl. 705/38

(57) ABSTRACT

Method and apparatus for managing financial transactions for multiple counterparties that allows traders, market makers, dealers, and prime brokers to negotiate with multiple liquidity providers simultaneously, and to receive and respond to transaction processing directives and settlement instructions in real time. The invention, which may be accessed over an interconnected data communications network, such as the Internet, using a standard Web browser, as well as via a proprietary user interface, automatically provides customers, traders, executing banks, funding banks, prime brokers and liquidity providers with up-to-date settlement and allocation details for previously-executed financial transactions as they are received.

### RELATED APPLICATIONS

This application is related to and claims priority under 35 U.S.C. §119 to provisional application No. 60/389,481, filed on Jun. 19, 2002, provisional application No. 60/395,348, filed on Jul. 12, 2002, and provisional application No. 60/461,145, filed on Apr. 9, 2003, all of which are incorporated into this application in their entirety by this reference.

### FIELD OF ART

The present invention relates generally to financial transaction systems and, more specifically, to financial transaction systems where at least a portion of the transaction is conducted over an interconnected data communications network, such as the Internet.

### RELATED ART

In today's global market, money flows freely between investors and borrowers, and buyers and sellers, across international borders. Money markets, for example, allow market participants to borrow and lend money. In a money market transaction, one counterparty—the borrower—borrows money from the other counterparty—the lender—at a specified rate for a specified period of time. Money market instruments include coupon bearing instruments, such as certificates of deposit (CDs) and repurchase agreements, discount instruments, such as treasury bills, (T-bills) and commercial paper, and derivatives, such as forward rate agreements, interest rate futures and interest rate options.

In another example, foreign exchange (“FX”) markets allow market participants to exchange (or “trade”) one currency for another. In an FX transaction, one counterparty buys a specified currency from the other counterparty in exchange for another currency. FX market instruments include, for example, spot, forward and swap agreements (defined below).

As investments, most money market and FX instruments are “liquid,” meaning that they can be bought and sold, and therefore, converted to cash, rapidly. This liquidity is the reason many corporate treasurers use these markets to lend or sell spare cash to banks as a way of temporarily “parking” the spare cash in a short-term low-risk investment vehicle before making a financial decision. The banks use the spare cash to make loans to borrowers who need short-term financing. These borrowers may include, for example, other banks, corporations and governments, as well as supranational organizations, such as the World Bank.

Borrowers, lenders, sellers and buyers in these markets conduct their transactions through dealers, also called “traders,” who borrow and lend money market instruments or buy and sell FX instruments. The dealers and traders, who are referred to as “market-makers” or “liquidity providers,” quote prices that they are willing to buy (or borrow) the instruments they deal in, as well as prices they are willing to sell (or lend) the instrument. The borrowing or buying price is known as the “bid,” and the lending or selling price is known as the “offer.” The difference between these two prices is known as the “bid-offer spread,” and it is this spread which generates profits for market-makers, as they are always buying and borrowing slightly more cheaply than they are selling and lending.

For years, liquidity providers and their customers (the buyers, sellers, lenders and borrowers who do business with liquidity providers) would negotiate, execute, confirm and settle transactions, which are often called “deals,” from start to finish using only manual systems, either by meeting in person (such as at a stock or commodity exchange) or by using telephones and fax machines. But as the markets have grown, and as trading and dealing activities have expanded to cover 24 hours per day, the manual systems have been found to be too slow and inefficient to keep up with market requirements. Manual systems, for example, do not always provide adequate access to the people, prices and transaction records required to accommodate the fast pace and higher volumes of today's markets, or to deal with the financial risks associated with engaging in these transactions. Manual systems also typically do not provide adequate or timely access to current market news, market rates, market research and other information market participants need to have available and at their fingertips while they are making deals.

Confirmation matching is an automated check that verifies that two counterparties agree on transactional details. For many years, banks and other sell-side organizations invested heavily in technology and infrastructure in order to perform this automated process. The standard vehicle used for the delivery of confirmations is SWIFT, specifically, SWIFT MT300 messages. These messages are uploaded to a sophisticated matching engine that attempts to pair incoming messages to existing executed deals. The sophisticated matching system for matching trade details makes Straight-Through-Processing possible. Each paired (or matched) deal is automatically updated and paid without manual intervention. Items that are not paired are investigated manually for error resolution.

However, buy-side customers have very limited options for confirmation matching. Typically, they have avoided using SWIFT due to the expensive set-up and membership fees. Thus, buy-side customers usually have to confirm each deal manually via fax, e-mail, and voice (telephone). Those buy-side customers who do occasionally get access to automated confirmation matching systems usually encounter very high costs, non-scalable and unreliable service.

Another problem with manual systems is that they typically allow customers, dealers and providers to communicate with only one counterparty at a time, which can be a very time-consuming and unreliable way to obtain the best prices. Yet another problem with manual systems is that the records for these transactions, which often total very large transfers of money (and therefore create large financial exposures), frequently consisted of hastily-created, handwritten notes and faxes, which are sometimes lost, smudged, illegible, or otherwise unavailable when they are needed the most, such as during a financial audit. These and other problems made it extremely difficult to review, understand, and/or reconstruct exactly what happened during the course of a very large or very complex transaction negotiated and completed using manual systems.

Automated online transaction systems for customers and liquidity providers have been introduced in an attempt to address some of these problems. But the existing automated systems have so far failed to solve many of the most troubling aspects of the older manual systems. For example, like the manual systems, existing online transaction systems typically do not connect customers to multiple banks and providers simultaneously, which means customers must still spend an unacceptable amount of time shopping proposed transactions around for the best prices, when they would much rather have a number of banks and providers competing for their business. Moreover, the existing online trading systems do not provide customers with real-time, context-sensitive feedback on the status of proposed transactions. Another problem with existing online transaction systems is that they do not provide a way for customers and providers to confirm and settle previously-executed deals online. As a result, users must still resort to the older manual systems, e.g., telephones and fax machines, for confirmation matching and settlement purposes.

There are also significant investment and scalability problems associated with the existing automated online transaction systems. To reduce their transaction costs and keep pace with other market participants, banks need to offer their customers competitive price quotes for foreign exchange transactions through electronic means so that they can provide real-time or near real-time responses (a service known as electronic dealing). Where possible, banks prefer and achieve significant advantages by offering electronic dealing services directly to the customer as a branded part of the bank's service package.

But building a full rate streaming ability in order to provide electronic dealing services requires a significant technology investment and the expense of employing a market maker to monitor the prices. In many situations, however, the small volume of financial transactions executed by smaller banks do not justify this large investment. Meanwhile, the larger banks have been improving their price-making efficiency by making the large technology investments required for electronic dealing. As a result, the industry has seen a significant trend toward consolidation, whereby more and more foreign exchange transactions are executed by fewer and fewer of the larger banks. According to a poll conducted by Euromoney in 2002, for example, 45% of all foreign exchange transactions are handled by the top five banks. Two years ago the figure was just 36%.

In an effort to provide electronic dealing without making very large investments, smaller banks have attempted to outsource their liquidity transactions to larger banks. Previous attempts by both large and small banks to set up liquidity outsourcing initiatives have gained little traction in the industry, however, because they typically involve the smaller bank making a significant commitment to deal with one, and only one, large bank. For example, the smaller bank must typically invest in a customized technical integration, which ties the smaller banks computer system to the larger bank's proprietary quote-streaming system. To implement the commitment and protect the smaller bank from losses that might occur if the larger bank switched systems or failed to provide services as promised, the two banks usually have to negotiate a Service Level Agreement, further increasing the complexity of the outsourcing initiative.

Accordingly, there is need for an automated online transaction system that allows customers, dealers, traders and liquidity providers to confirm and settle previously-executed deals without having to resort to using manual systems. There is a further need for automated online transaction systems that provide smaller market makers, dealers, and liquidity providers with the ability to outsource liquidity transactions, thereby making it possible for them to offer prices competitive with the larger market makers, and larger organizations, who are typically unable or unwilling to take on the market risks associated with dealing with smaller borrowers, to reach the customers of the smaller banks of the market.

The present invention addresses all of these problems with conventional online transaction systems, as well as numerous other long-felt but so far unfulfilled needs.

### SUMMARY OF THE INVENTION

In general, the present invention comprises a computer system for processing a previously-executed financial transaction, comprising an interface to a data communications network, a message database, a settlement processor, coupled to the interface, configured to establish an online connection to a remote computer via the data communications network, to receive from the remote computer an incoming message containing a set of details pertaining to the previously-executed financial transaction, and to store the incoming message in the message database.

In a preferred embodiment, the settlement processor is further configured to provide a match status to the remote computer (via the online connection) prior to booking the previously-executed financial transaction. The match status indicates to the remote computer (and therefore the remote user) whether a match was found. The remote user may then be prompted to provide processing and settlement instructions, which are transmitted back to the settlement processor, which is configured to inform counterparties what actions to take with respect the settlement details. In some cases, the match status may indicate the fact that a match was found and simply prompt the remote user for confirmation to proceed with the transaction. In other cases, the match status may indicate that a match was not found for certain detail sets, thereby prompting the user to take other actions. In still other cases, the match status may indicate, for example, that multiple matches have been found, that the transaction pertaining to the details has been cancelled by a counterparty, etc.

The settlement processor also may comprise a session manager configured to control the online connection, and a user interface manager configured to control data communications with the remote computer. In a preferred embodiment, the user interface manager is further configured to control or facilitate data communications with an adapter program (described below) that may be running on the remote computer.

A computer system consistent with embodiments of the present invention also includes a matching subsystem configured to determine whether a match exists between the set of details in an incoming message and a second set of details in a second message. In a preferred embodiment, the matching subsystem comprises a workflow processor component, and a matching engine configured to compare the first set of details to the second set of details under the control of the workflow processor. Prior to making the determination, the matching subsystem may be configured to retrieve both messages from a message database. If a match is found, the matching subsystem (or, alternatively, the settlement processor) may be further configured to permanently book the previously-executed financial transaction (thereby removing a provisionally booked status).

The computer system may further include a message database configured to store messages containing the transaction details. If such a message database is provided, the workflow processor (or, alternatively, the settlement processor) may be further configured to store and retrieve the messages to and from the message database, and to control the workflows associated with matching messages stored in the message database.

In some embodiments, the computer system may further include a deal execution-stage processor configured to receive, via another online connection, an original request, such as an RFQ, from a party (such as a Customer) to participate in the previously-executed financial transaction (such as by receiving quotes) and to provisionally book the previously-executed financial transaction prior to the matching subsystem determining whether the match exists. For example, the present invention may be advantageously combined with the execution- and post execution-stage inventions described in co-pending application Ser. No. 10/237,972, entitled, “METHOD AND APPARATUS FOR CONDUCTING FINANCIAL TRANSACTIONS,” and Application Ser. No. 10/237,980, entitled, “METHOD AND APPARATUS FOR AMENDING FINANCIAL TRANSACTIONS,” which were both filed on Sep. 10, 2002, and which are assigned to the assignee of the present application. Both of these co-pending applications are hereby incorporated herein in their entirety by this reference.

The financial transaction detail sets typically comprise at least one field identifying a counterparty for the previously-executed financial transaction. Thus, the settlement processor is further configured, in a preferred embodiment, to establish a second online connection to the counterparty named in the field, and to book the previously-executed financial transaction only after receiving a confirmation from the counterparty via the second online connection. In addition, the settlement processor may be further configured to generate and send to interested parties a notice indicating that the previously-executed financial transaction has been booked.

In some embodiments, the invention includes an adapter program, configured to execute on the remote computer in cooperation with or under the control of the settlement processor. The adapter program receives the incoming message from a user application running on the remote computer, and transmits the incoming message from the remote computer to the settlement processor over the data communications network. In cases where the user application running on the remote computer provides message data in a format not compatible with the settlement processor or matching subsystem (usually because the user application is a proprietary software program), the adapter program may be further configured to translate the incoming message into a compatible format before delivering the message to the settlement processor. The adapter program may also be configured to receive the outgoing message from the settlement processor via the data communications network, and to send the outgoing message to the user application. If necessary, the adapter program is also configured to translate the outgoing message into a format compatible with the user application.

The message translation functionality may also reside elsewhere in the computer system of the present invention. For example, the settlement processor (rather than the adapter program) may be configured to translate the incoming message into a format compatible with the matching subsystem prior to making the message available to the matching subsystem by storing the incoming message in the message database. A variety of different formats known to those of skill in the industry may be used for message data, including, for example, XML hypertext transport markup language (HTML) or the SWIFT MT300 format.

The data communications network and the online connections may comprise components of any local area or wide area network, or any interconnected network of computers, including, for example, a corporate Intranet, the Internet, a virtual private network or the SWIFT network, which is a network used in the world financial markets for handling financial transactions.

The invention also provides a computer-aided method for settling a previously-executed financial transaction, comprising the steps of receiving from a Party-A a Party-A-perspective set of details for the previously-executed financial transaction, receiving from a Party-B a Party-B-perspective set of details for the previously-executed financial transaction, determining whether the Party-A-perspective set of details matches the Party-B-perspective set of details, establishing an online connection for the Party-A via a data communications network, the online connection being configured to convey information pertaining to the previously-executed financial transaction to the Party-A, and transmitting the Party-A-perspective set of details and the Party-B-perspective set of details to the Party-A via the online connection. If a match is found between the Party-A-perspective set of details and the Party-B-perspective set of details, the previously-executed financial transaction may be booked, or alternatively, flagged for booking pending the receipt of a confirmation or acceptance from the Party-A.

In most, but not necessarily all contexts, the Party-A is a customer looking to buy or sell financial instruments, and Party-B is a dealer, trader, market-maker or liquidity provider, such as a bank or other institution, who deals the financial instruments the Customer wishes to acquire.

The method may further include the step of providing a match status to the Party-A via the online connection prior to performing the step of booking the previously-executed financial transaction and, even further, the step of avoiding booking the transaction until an acceptance and confirmation of the transaction details have been received from the Party-A and the Party-B, respectively. In some embodiments, the invention also includes the optional step of receiving, via another online connection, an original request from the one of the parties to the transaction to participate in the previously-executed financial transaction, such as through an original RFQ posted through an execution-stage automatic trading system, and provisionally booking the previously-executed financial transaction prior to determining whether the match exists.

The inventive method may further comprise establishing a second online connection for the Party-B, the second online connection being configured to convey information pertaining to the previously-executed financial transaction to the Party-B, and transmitting the Party-A-perspective set of details and the Party-B-perspective set of details to the Party-B via the second online connection. If there a match is found between the Party-A-perspective set of details and the Party-B-perspective set of details, a match status indicating the match also may be supplied to the Party-B via the second online connection. On the other hand, if no match is found, the match status could be configured to indicate a non-matching status as well.

In a preferred embodiment, the method further comprises receiving, via the online connection for the Party-A, a processing directive from the Party-A responsive to the match status, and receiving a confirmation for the processing directive from the Party-B via the second online connection. In such embodiments, the next step, booking the transaction, may be conditioned upon receiving the processing directive and the confirmation.

The previously-executed financial transaction may comprise, but does not have to comprise, a foreign exchange transaction. In other words, the transaction could also comprise a variety of other types of financial transactions, including but not limited to, a stock or money market transaction.

In the preferred embodiment, each of the receiving steps comprises receiving a SWIFT MT300 confirmation message. Moreover, the Party-A-perspective set of details and the Party-B-perspective set of details typically include, among other things, economic details, account identifiers and counterparty identifiers for the previously-executed financial transaction. Preferably, although not necessarily, a messaging database is used for storing messages and transaction details for the previously-executed financial transaction.

As stated above, the preferred embodiment of the invention includes using a deal execution-stage computerized online transaction processing system, such as the foreign exchange trading portal operated by FX Alliance, Inc. of New York, N.Y. (www.fxall.com), known as the Fxall Treasury Center, to negotiate and create the previously-executed financial transaction. However, the previously-executed financial transaction also may be initiated, negotiated and created through a variety of manual methods, such as by telephone, facsimile or a face-to-face meeting, such as would occur at a trading exchange.

In yet another aspect of the invention, there is provided a computer-aided method for processing a plurality of previously-executed financial transactions. In this aspect, the method comprises receiving an incoming message associated with a previously-executed financial transaction in the plurality of previously-executed financial transactions, the previously-executed financial transaction involving a Party-A and a Party-B, determining whether the incoming message comprises a set of details matching a second set of details contained in a message previously-received from the Party-A or the Party-B, establishing an online connection with the Party-A, the online connection being configured to convey information pertaining to the previously-executed financial transaction to the Party-A, transmitting the set of details and the second set of details to the Party-A via the online connection. If there is a match between the set of details and the second set of details, the previously-executed financial transaction may be booked.

As with the previous aspects, this method may further include the steps of providing a match status to the Party-A via the online connection prior to the step of booking the previously-executed financial transaction, and provisionally booking the previously-executed financial transaction prior to the step of determining whether the match exists. The booking step may comprise the steps of establishing a second online connection for the Party-B, the second online connection being configured to convey information pertaining to the previously-executed financial transaction to the Party-B, receiving from the Party-A, via the online connection, a processing directive responsive to the match status, transmitting the processing directive to the Party-B via the second online connection; and receiving from the Party-B, via the second online connection, a confirmation responsive to the processing directive.

The receiving step may comprise storing the incoming message in a message database, determining whether the incoming message comprises an amendment request for a message previously received from the Party-A, determining whether the incoming message comprises a cancellation request for a message previously received from the Party-A, and/or determining whether the incoming message comprises a set of settlement instructions. If the incoming message does not comprise settlement instructions, the invention optionally performs the step of adding a set of settlement instructions to the incoming message.

The receiving step may also comprise placing the incoming message in a message matching queue and sending a notification to the Party-B indicating that the incoming message has been received. In preferred embodiments, notifications may also be sent to third parties (such as Prime Brokers or funding banks), indicating that the incoming message has been received. Further still, in some embodiments the receiving step may include converting the incoming message to SWIFT MT300 format.

In addition, the determining step may include assigning a match status to the incoming message, and sending a notification to interested parties and participants indicating that the second set of details has been matched.

Once the messages have been matched, the invention may be configured to accept a settlement instruction election from the Party-A for instructions for settling the financial transactions pertaining to the matched set. Thus, the Party-A user may elect to use a pre-defined set of standard settlement instructions, to provide a completely new set of settlement instructions, or to edit a pre-defined set of instructions.

The method may further comprise the step of presenting the user (usually the Party-A or customer) a set of netted settlement payments for the plurality of previously-executed financial transactions. Typically, although not necessarily, calculating netted settlement payments includes the steps of receiving from the Party-A via the online connection a selected value date and a selected combination of accounts and counterparties for a subset of previously-executed financial transactions in the plurality of previously-executed financial transactions, and calculating the set of netted payments for the subset based on the selected value dates and the selected combinations. The set of netted settlement payments are then transmitted to the Party-A via the online connection for a confirmation instruction and to each counterparty in the selected combination for approval.

Furthermore, the netting calculation may be carried out using a specified netting mode. The specified netting mode may require, for example, producing a netted payment for each currency pair in the subset of previously-executed financial transactions. Alternatively, the specified netting mode may require producing a netted payment for each currency in the subset of previously-executed financial transactions. These modes are called “bi-lateral netting.” However, the specified netting mode might also call for “multi-lateral” netting, which is a process that produces a set of netted payments to be paid directly between two or more counterparties other than the Party-A, in order to reduce or eliminate settlement payments to be paid by the Party-A. Netting modes are explained in more detail below in the section entitled “Netting.”

In yet another aspect of the present invention, a client-server model computer system for processing financial transactions, is provided. The client-server model computer system comprises a settlement server program and a matching subsystem, operating under control of the settlement server program, configured to generate a match status for two sets of financial transaction details pertaining to a previously-executed financial transaction. The settlement server program is configured to transmit the two sets of transaction details and the match status to a broker client program via a first data communications channel, and to accept from the broker client program a processing directive responsive to the match status. The settlement server program then transmits the processing directive to a provider client program via a second data communications channel and a customer client program via a second data communications channel, and, responsive to the input, books the previously-executed financial transaction. Notably, the provider input may also arrive before the processing directive.

In still another aspect of the present invention, there is a provided a computer system for implementing the concept of prime brokering a financial transaction between a Party-A (typically, a customer), a Party-B (an executing bank) and a Party-C (the prime broker). In a prime brokered transaction, Party-A and Party-B agree to execute a transaction with the understanding that each will use Party-C as an intermediary in the deal. Accordingly, the parties agree to “give up” the transaction to the Party-C.

Consistent with this aspect, the computer system comprises an interface to a data communications network, a settlement processor, coupled to the interface, configured to establish a first online connection for the Party-A via the data communications network, to establish a second online connection for the Party-B via the data communications network, to receive from the Party-A, via the first online connection, a set of Party-A give-up details pertaining to a first financial transaction between the Party-A and the Party-C, and to receive from the Party-B, via the second online connection, a set of Party-B give-up details pertaining to a second financial transaction between the Party-B and the Party-C.

There is also included a matching subsystem configured to determine whether a match exists between the Party-A give-up details and the Party-B give-up details, and, if the match exists, the settlement processor is further configured to book the first financial transaction between the Party-A and the Party-C, and to book the second financial transaction between the Party-B and the Party-C. In a preferred embodiment, the settlement processor is further configured to provide a match status to the Party-A via the first online connection prior to booking the first financial transaction and a match status to the Party-B prior to booking the second financial transaction.

As with the previously-described aspects of the present invention, the preferred embodiment includes a deal execution-stage processor configured to receive, via another online connection, an original request from the Party-A to participate in the previously-executed financial transaction with the Party-B, and to provisionally book the first and second financial transactions prior to the matching subsystem determining whether the matching settlement details have been found.

Typically, the original request from the Party-A to participate in the previously-executed financial transaction with the Party-B is an RFQ that is based on an prior arrangement (such as a written contract or oral agreement) between the Party-A and the Party-C. The arrangement may specify, for example certain restrictions the Party-C has imposed on transactions initiated by the Party-A, such as a credit limit, a currency pair restriction, a forward date limitation, a requirement to use a specified account or group of accounts, an execution date restriction, a settlement date restriction, or some combination of one or more of all of the above.

An advantage of using a deal execution stage processor, such as the Fxall Treasury Center, for example, to execute the previous transaction is that the deal execution stage processor may be configured to check the arrangement between Party-A and Party C even before the RFQ is sent to the Party-B. This functionality provides a way for Party-C and Party-B to manage their exposures to the market and credit risks associated with dealing with the Party-A and to prevent Party-A from executing deals that are not specifically authorized.

The settlement processor in this aspect of the present invention may be further configured to establish a third online connection for the Party-C, to transmit the Party-A give-up details to the Party-C on behalf of the Party-A, and to transmit the Party-B give-up details to the Party-C on behalf of the Party-B. Preferably, notices are sent to the Party-A and the Party-B indicating that the Party-A give-up details and the Party-B give-up details have been transmitted to the Party-C.

Furthermore, in a preferred embodiment, the settlement processor receives a Party-C give-up acceptance from the Party-C responsive to the transmission to the Party-A give-up details and the Party-B give-up details, transmits the Party-C give-up acceptance to the Party-A and to the Party-B on behalf of the Party-C, and books the financial transaction based on the acceptance. Notably, the first financial transaction between the Party-A and the Party-C may be booked at a slightly higher rate than the second financial transaction between the Party-B and the Party-C, thereby providing the Party-C with a per transaction fee for participating in the transaction. Alternatively, the Party-C could periodically invoice the Party-A for such participation.

In a preferred embodiment, the settlement processor is further configured to transmit a notification to the Party-A and to the Party-B that the first and second financial transactions have been booked.

In certain situations, the Party-A and the Party-B may choose not to give up the entire transaction to the Party-C. A system operating according to the present invention may be configured to handle this situation as well. Thus, the settlement processor may be further configured to receive from the Party-A, via the first online connection, a set of Party-A details pertaining to a third financial transaction between the Party-A and the Party-B, wherein the third financial transaction comprises a portion of the previously-executed financial transaction not given up to the Party-C. In such cases, the settlement processor may be further configured to receive from the Party-B, via the second online connection, a set of Party-B details pertaining to the third financial transaction. The matching subsystem is further configured to determine whether a second match exists between the Party-A details and the Party-B details, and, if the second match exists, the settlement processor is further configured to book the third financial transaction.

As with the other embodiments and aspects, the settlement processor may also be configured to provide a match status for the Party-A details and the Party-B details prior to booking the third financial transaction, and to provisionally book the third financial transaction prior to the matching subsystem determining whether the second match exists.

Preferably, the settlement processor is further configured to receive from the Party-C a set of settlement details based on a fund allocation (a set of “splits”) provided by the Party-A, and to establish a fourth online connection for a Party-D (typically a funding bank), and to transmit the set of settlement details to the Party-D via the fourth online connection. Among other things, the set of settlement details may comprise data representative of a funding account, a funding amount, a value date, or some combination of one or more of all of the above. Moreover, the settlement processor is further configured to receive from the Party-D a Party-D settlement confirmation message responsive to the set of settlement details, to transmit the Party-D settlement confirmation message to the Party-C on behalf of the Party-D, to receive from the Party-C a Party-C confirmation message responsive to the Party-D settlement confirmation message; and to transmit the Party-C settlement confirmation message back to the Party-A. The matching subsystem may then be configured to determine whether there is a match between the Party-C settlement confirmation message and the set of settlement details originally provided by the Party-A.

In still another aspect of the present invention, a computer-aided method for processing prime brokered transactions involving a Party-A and a Party-B, is provided. The method comprises the steps of establishing a first online connection for the Party-A via a data communications network, establishing a second online connection for the Party-B via the data communications network, receiving from the Party-A, via the first online connection, a set of Party-A give-up details pertaining to a first financial transaction between the Party-A and a Party-C, receiving from the Party-B, via the second online connection, a set of Party-B give-up details pertaining to a second financial transaction between the Party-B and the Party-C, determining whether a match exists between the Party-A give-up details and the Party-B give-up details; and, if the match is found, booking the first financial transaction between the Party-A and the Party-C, and booking the second financial transaction between the Party-B and the Party-C.

Optionally, the method includes the steps of receiving, via another online connection, an original request from the Party-A to participate in the previously-executed financial transaction with the Party-B, provisionally booking the first financial transaction prior to the matching subsystem determining whether the match exists, and provisionally booking the second financial transaction prior to the matching subsystem finding a match. In the preferred embodiment, an arrangement between the Party-A and the Party-C authorizing the Party-A to make the original request is checked prior to transmitting the original request to the Party-B.

In yet a further aspect, the present invention provides a computer-aided method for processing financial transactions by outsourcing liquidity transactions. This method comprises the steps of: (1) receiving an original trading request for an original financial transaction from a customer, the original trading request being directed to an executing bank having a relationship with the customer; (2) generating a secondary trading request based on the original trading request; (3) submitting the secondary trading request to a set of providers on behalf of the relationship bank, the set of providers being selected based on a set of outsourcing rules; (4) receiving from a subset of the set of providers an original stream of responses responsive to the secondary trading request; (5) selecting one or more responses from the original stream of responses to form a secondary stream of responses, (6) transmitting the secondary stream of responses to the Party-A on behalf of the Party-B; (7) receiving an acceptance from the Party-A responsive to the secondary stream of responses; and (8) responsive to the acceptance, (i) choosing a selected provider based on the original stream of responses and a set of arbitration rules, (ii) forwarding the acceptance to the selected provider on behalf of the relationship bank, (iii) receiving a confirmation from the selected provider responsive to the acceptance, and (iv) substantially simultaneously with receiving the confirmation, booking a pair of financial transactions, the pair of financial transactions comprising a first financial transaction between the customer and the relationship bank, and a second financial transaction between the relationship bank and the selected provider.

The original and secondary trading requests may comprise requests for responses (RFQs) and the original and secondary streams of responses may comprise streams of price responses. In the foreign exchange market, for example, customers and providers have established a convention of using the RFQ protocol to initiate transactions. However, there are numerous alternatives to the RFQ protocol, such as the “At Best” protocol, the “Kill or Fill” protocol, the “Resting Order” and the “At Fix” protocol, all of which are described in more detail below.

Preferably, although not necessarily, the set of outsourcing rules and the set of arbitration rules are specified by the relationship bank, and the step of selecting the one or more responses from the original stream of responses occurs on a real time basis. Moreover, in the preferred embodiment, the method includes the step of adding a spread to the one or more responses selected from the original stream of responses. In this aspect, the set of outsourcing rules and the set of arbitration rules may be based on a variety of factors associated with the parties and the markets in general. For example, these rules may be based on a currency designation associated with the original trading request, a time zone associated with the original trading request, a credit risk associated with the customer, a market risk associated with the original trading request, a funding amount associated with the original trading request, an availability status associated with one or more providers in the set of providers, a target percentage of business associated with one or more providers in the set of providers, an available credit status for the relationship bank with one more providers in the set of providers, a performance metric or service level agreement to a service level agreement for one or more providers in the set of providers, etc. The outsourcing and arbitration rules also may be based on a combination of one or more of all of the above-listed factors. Application of the outsourcing and arbitration rules may be implemented, in a preferred embodiment, by means of a relationship router program or processor.

The invention may also include tracking a set of performance metrics for each provider in the set of providers to form a historical performance record for the set of providers and automatically adjusting the rules based on the historical performance record. These metrics may include, for example, a number of confirmations received, an average response time, an average price differential, an average price stability rating, an average bid-offer spread or a percentage of offers to deal confirmed. The metrics may also be based on a percentile ranking for one or more providers in one of the above-listed categories.

The system accounts for the fact that some of the providers who receive the secondary trading request will respond to the trading request in the required time period. Some of the providers may not respond at all. In such cases the set of arbitration rules may be adapted so that the secondary trading request will be sent to a second set of providers (or resent to the first set of providers) if not enough providers provide responses. The system may even be configured, for example, to initially send the secondary request to only one provider. If that provider fails to respond in the required time period, say 10 seconds, another secondary trading request may then be sent to another provider (or set of providers). If the first provider then responds, the arbitration rules can also dictate whether to accept that response or ignore it.

In some embodiments, the invention may be implemented as a web-based rate engine. The system may be centrally hosted by Fxall, Inc. or another trading platform. In a preferred embodiment, the rate engine connects to a server running the FXall Trading Center application. Each trade request sent by a customer can be transparently directed to one or more liquidity providers using rules established by the relationship bank. The customer, who may or may not be aware of the redirection process, receives a world-class price within a few seconds. The relationship bank may optionally choose to handle the RFQ itself, which allows it to participate in profitable niches, or allow the RFQ to be handled by the liquidity provider.

### FEATURES AND ADVANTAGES

It is a feature of the present invention that it provides an automated online confirmation matching system for both buy-side and sell-side participants.

It is another feature of the present invention that it provides a way for banks and liquidity providers to implement fully automated real-time prime brokering services, including automatic delivery of transaction details to various parties, Straight-Through-Processing and automated credit risk management functionality.

It is still another feature of the present invention that it can be used to provide liquidity-outsourcing services, and that such liquidity outsourcing services may provide access to price quotes from literally dozens of providers simultaneously. It is another feature of the present invention that it provides intermediary banks with the ability to specify, manage and change liquidity routing relationships with the multiple providers through outsourcing and arbitration rules that can be adapted to suit many different objectives.

Moreover, because the execution is taking place by electronic means (as opposed to manual methods, such as by facsimile or telephone), the confirmation and settlement messages can flow to multiple parties substantially simultaneously. Real time or near-real time transaction processing makes it possible to achieve “atomic” trades between three or more parties, whereby all of the parties confirm their participation substantially at the same time. Thus, an advantage of using the present invention for liquidity outsourcing is that the bank having the relationship with the customer (called the “relationship bank”) does not need to actually accept or deny the offer to deal from a client. Thus, the relationship bank is not forced to take on market risk.

With the present invention, it is easy for the relationship bank not only to use multiple liquidity providers, but to switch between liquidity providers as the need arises. The invention can even be configured to provide the switching automatically. For example, the relationship bank could elect to send 75% of its incoming customer RFQs to the relationship bank's primary liquidity provider and the other 25% to the relationship bank's secondary provider. In addition, an trading request sent to the relationship bank can be sent to multiple liquidity providers who will then compete for the opportunity to execute the deal.

Benefits for customers include the convenience of trading through a relationship bank, as well as improved product coverage and more consistent pricing. Smaller banks (typically, the relationship banks) benefit by being able to provide a higher quality of service for their customers, while lowering outsourcing costs and eliminating the market risks associated with providing liquidity directly. And larger banks benefit because the invention provides the ability to exploit an investment in pricing technology, while allowing them to provide liquidity services to new customers without creating credit relationships.

In a preferred embodiment, the invention also provides other facilities designed to minimize the time and investment needed to set up an electronic dealing service. This embodiment comprises providing or including an integrated credit engine, so that credit can be checked pre-trade without the need to build a real-time interface into the bank's own credit engine. An optional real-time deal feed may also be included to provide full straight-through processing for both banks to reduce ticket-processing costs.

### BRIEF DESCRIPTION OF THE DRAWINGS

The invention will be better understood with respect to the accompanying drawings, which constitute a part of this specification and include exemplary embodiments of some of the various forms of the invention. In these drawings:

FIG. 1 shows a high-level block diagram of a computer system configured to operate in accordance with the present invention.

FIG. 2 is a high-level flow diagram showing the steps that might be performed by a computer system or computer processor configured to operate in accordance with an embodiment of the present invention.

FIGS. 3 through 7 contain flow diagrams illustrating in more detail the steps that might be performed in a computer system or processor configured to operate in accordance with an embodiment of the present invention.

FIGS. 8 and 9 contain flow diagrams illustrating the steps that might be performed by a computer system or processor operating in accordance with embodiments of the present invention in order to implement settlement netting functionality.

FIGS. 10, 11 and 12 contain flow diagrams illustrating the steps that might be performed by a computer system or processor operating in accordance with embodiments of the present invention in order to implement settlement and the prime brokering function functionality.

FIG. 13 contains a block diagram illustrating the overall message protocols used for the prime brokering function.

FIGS. 14 through 18 contain additional, more detailed flow diagrams illustrating the operation of the liquidity outsourcing process.

FIG. 19 contains a flow diagram illustrating the overall process steps that might be performed by a computer system or processor operating in accordance with embodiments of the present invention in order to implement liquidity outsourcing functionality.

### DETAILED DESCRIPTION OF THE PREFERRED EMBODIMENTS

Although the detailed description of preferred embodiments provided herein refers primarily to foreign exchange (FX) deals, these references are only meant to illustrate in clearer detail how the invention may be applied in that particular context, not to serve as a limitation on the applicability of the invention in other contexts. Therefore, such references should not be construed to remove from the scope of the present invention other kinds of financial transactions that could benefit from its application, such as fixed income, equities and money market transactions.

Definition of Terms

As used in this description, except to the extent that the context indicates otherwise, the following terms may be understood with reference to the definitions provided below.

FX Terms

A “foreign exchange” or “FX” transaction (or “deal”) is a contract to exchange one currency for another at an agreed rate on a specified delivery date, also called a “value date.”

A “value date” or “settlement date” is the date on which the exchange of currencies will take place.

The terms “FX spot deal,” “spot trade” and “spot agreement” refer to a transaction or agreement to exchange a single foreign currency for another (i.e., to buy X units of one currency, sell Y units of another currency) on the FX spot date.

The “FX spot date” is usually two working days from the date the agreement is made and is the most liquid (i.e. cheapest) date to buy or sell currency on a given trading date.

The term “swap” or “swap agreement” refers to a deal involving the simultaneous purchase and sale, or sale and purchase, of a specified amount of one currency against another for two different value dates. Although a swap is a single transaction with a single counterparty, the transaction has two value dates (or “legs”) when the exchanges of funds occur.

A “spot rate” is a rate (expressed as combination of a bid (buy) price and an offer (sell) price) at which a market maker will buy and sell the base currency against another currency.

The term “All-in rate” typically refers, in the context of outrights, to the overall rate at which the exchange will occur. The all-in rate is calculated by adding the spot rate and the FX points (the price adjustment).

A “single spot portfolio” (SSP) is an FX deal involving one or more legs in a single currency pair on any combination of value dates. The dealt currency should be the same for all legs. SSP price quotes typically have four components: a spot rate, the FX points for each of the non-spot value dates, and the all-in rates for each of the non-spot value dates.

A “multiple spot portfolio” or “multi-spot portfolio” (MSP) is an FX deal involving one or more legs in multiple currency pairs on any combination of value dates. The dealt currency is not the same for all legs.

Parties

The term “Provider” is typically a shorthand reference to a “Liquidity Provider.” A “Liquidity Provider” is typically a financial institution, such as a bank, that serves as a market maker in a trading system. Liquidity Providers quote prices in response to requests from “customers.”

The term “bank,” as used herein, is typically used interchangeably with “Provider.”

The term “dealer” or “trader” typically refers to an employee of the bank or Liquidity Provider who monitors the system from the Provider side and responds to Customers' requests for price quotes.

The term “Customer” typically refers to a user of the system who is not a Bank, Provider, dealer or trader. Customers initiate the dealing process by asking one or more Providers for a price on a particular FX instrument, such as a swap, forward or spot transaction. While “customer” is typically essentially interchangeable with “user,” in some cases, depending on the context, a “customer” may also refer to an aggregation of users, as, for example, in a company.

The term “Prime Broker” refers to an intermediary party who has a relationship with a Customer, who is willing to take on the Customer's credit risk in a foreign exchange transaction, so that the Customer may engage in a transaction with an Executing Bank (defined below).

The term “Executing Bank” refers to the Bank or other institution providing liquidity (through a Prime Broker) to the Customer, and therefore taking on the market risk for the transaction, but not taking on any credit risk associated with dealing with the Customer.

The “Funding Bank” is the bank or other institution in physical control of the funds and accounts to be used in the financial transaction.

Features

The term “Provider Pricing Tool,” or PPT, refers to a system configured in accordance with the present invention, which enables Providers to receive and respond to price and amendment requests submitted by Customers. The PPT may also be referred to, in some embodiments of the present invention, as a “Treasury Center” or “Treasury Desk” program, or a “treasury desk application.”

Miscellaneous Concepts

The term “Straight-through-Processing” refers to the end-to-end automation of the trading process from order to settlement. It involves the seamless, automated, electronic transfer of trade information to all parties involved in the trading cycle as early as possible.

Acronyms

API—Application Programmer Interface. Used colloquially without expansion to denote a computer-to-computer interface.

OMS—Order Management System. An Order Management System is used by a Customer to maintain a record of which FX deals need to be executed in the market, who should execute them, etc. Once a deal is executed, the OMS is updated with the execution rate for each deal.

SSP—Single Spot Portfolio. A foreign exchange transaction or “deal” involving multiple value dates for a single currency pair. The Provider quotes a single spot rate (hence the name) together with FX points for each value date.

MSP—Multiple Spot Portfolio. A foreign exchange transaction or “deal” involving multiple value dates for multiple currency pairs.

RFQ—Request For Quote. A trading protocol whereby the customer initiates a trade by asking for a price on a particular currency pair, value date, and amount. The bank responds by sending a price. In order to accept the price, the Customer sends the Provider an “Offer to Deal.”

USD—United States Dollars.

GBP—United Kingdom Sterling

JPY—Japanese Yen

CHF—Swiss Franc

EUR—European Euro

CAD—Canadian Dollars

NOK—Norwegian Kroner

### OVERVIEW OF THE INVENTION

The present invention provides an effective, low cost way for financial transaction counterparties, such as Customers, banks, liquidity providers, brokers, and market-makers, to manage financial transactions across multiple counterparties and to automatically and efficiently monitor, amend, confirm and provide additional settlement instructions and details for such financial transactions. The executed transactions may have taken place on an electronic trading computer system or platform, or it could have occurred via one or more manual systems, such as by telephone or fax.

High-Level Architecture Description

A high-level description of the overall architecture for the present invention, followed by a more detailed description of some of its components (e.g., the matching and prime brokering applications, etc.), is now provided.

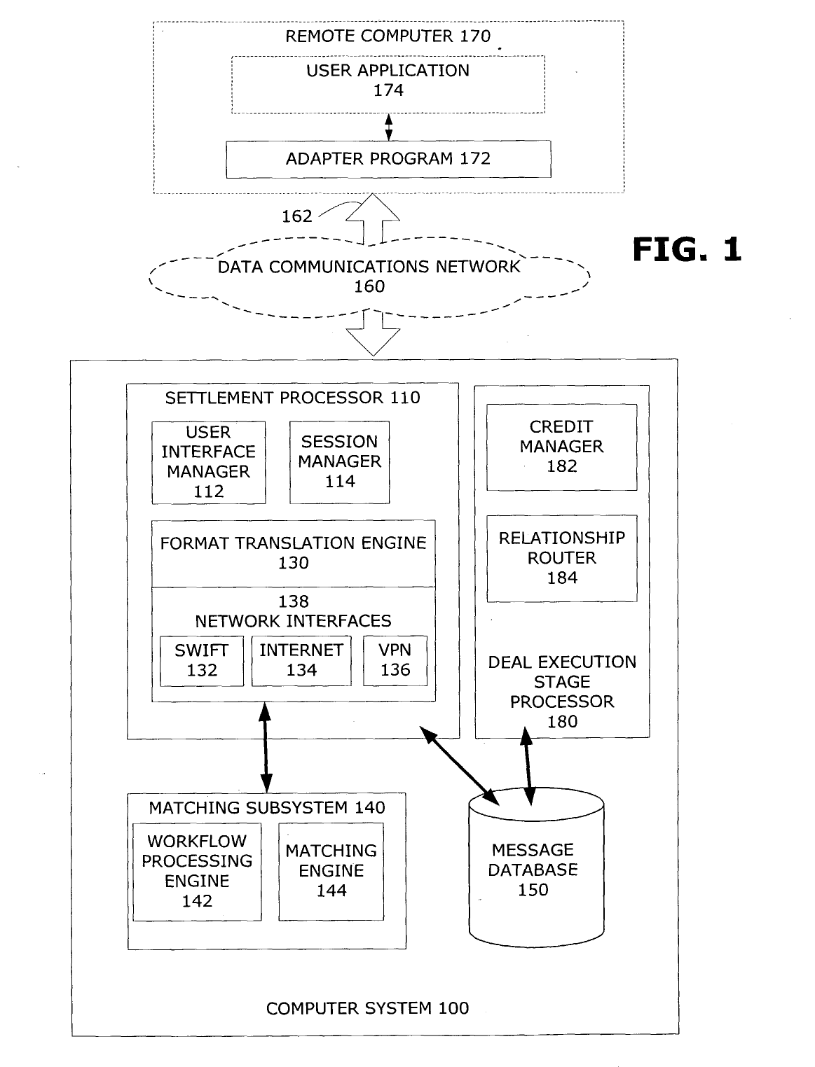

FIG. 1 shows a high-level block diagram of a computer system configured to operate in accordance with the present invention. As shown in FIG. 1, a computer system 100 according to the principles of the present invention comprises network interface 138, a message database 150, a settlement processor 110, coupled to the interface 138, a matching subsystem 140. The network interface 138 may optionally include interfaces to various types of data communications networks, such as the Internet, a corporate Intranet, a virtual private network or the SWIFT network. Accordingly, and as shown in FIG. 1, the network interface 138 may include separate network interfaces (shown in FIG. 1 as Swift 132, Internet 134 and VPN 136) for connecting to these kinds of data communications networks.

In preferred embodiments, settlement processor 110 is configured to establish an online connection 162 to remote computer 170 via data communications network 160, and to receive from the remote computer 170 incoming messages containing transaction details pertaining to a previously-executed financial transaction.

In some embodiments, the invention includes an adapter program 172, which is coupled to settlement processor 110 via the online connection 162, and configured to execute on the remote computer 170 in cooperation with or under the control of the settlement processor. As a straight through processing adapter, adapter program 172 provides a link to any user application (designated 174 in FIG. 1) running on the remote computer 170, which may be utilizing a proprietary messaging format for straight through processing of financial transactions. Preferably, adapter program 172 is configured to provide integration with most or all of the major proprietary messaging formats in the marketplace. Thus, if the user on the remote computer conducts financial transactions using a basic spreadsheet or a complex treasury management system, adapter program 172 is configured to translate transaction messages to the appropriate format for communication with settlement processor 110. One such generic adapter program, known as QuickConnect, is available from Fxall, Inc. of New York, N.Y. (www.fxall.com). In cases where, as shown in FIG. 1, settlement processor 110 is configured to operate with multiple types of networks, a format translator, shown as format translation engine 130, is provided to convert messages into a common format compatible with the matching subsystem (described below).

Notably, adapter program 172 is also configured, in preferred embodiments, to receive messages from settlement processor 110 via the online connection 160 through data communications network 160, and to send those messages to the user application. If necessary, the adapter program is also configured to translate the outgoing message into a format compatible with the web or application-based user interface.

Settlement processor 110 also comprises a session manager 114 configured to control the online connection 162 and a user interface manager 112 configured to control data communications with the remote computer 170. As messages come in from remote computer 170 via data communications network 160 and online connection 162, settlement processor 110 stores the messages in message database 150.

Matching subsystem 140 determines whether a match exists between the set of details in an incoming message and a second set of details in a second message. Thus, matching subsystem 140 further comprises a workflow processing engine 142 and a matching engine 144. Matching engine 144 is configured to compare the details of pairs of messages under the control of the workflow processing engine 142, which manages the task of removing messages from message database 150 for matching purposes.

Optionally, the computer system 100 further includes a deal execution-stage processor 180 configured to receive original trading requests, such as RFQs, from remote computer 170 and to provisionally book the transaction prior to the matching subsystem 140 determining whether the match exists. Preferably, although not necessarily, the computer system 100 further comprises a credit manager 182, or at least access to a credit database (not shown in FIG. 1), and deal execution processor 180 is further configured to check a customer's credit status prior to booking certain transactions on behalf of the customer. In a preferred embodiment, Deal execution stage processor 184 also includes a relationship router 184, which is configured to control outsourcing to liquidity providers according to outsourcing and arbitration rules provided by a relationship bank.

High-Level Summary of Processes

Generally speaking, the present invention covers six areas related to managing financial transactions and settlement details. These seven areas include confirmation matching, netting, settlement instructions, third party notifications, prime brokering, liquidity outsourcing, and relationship routing.

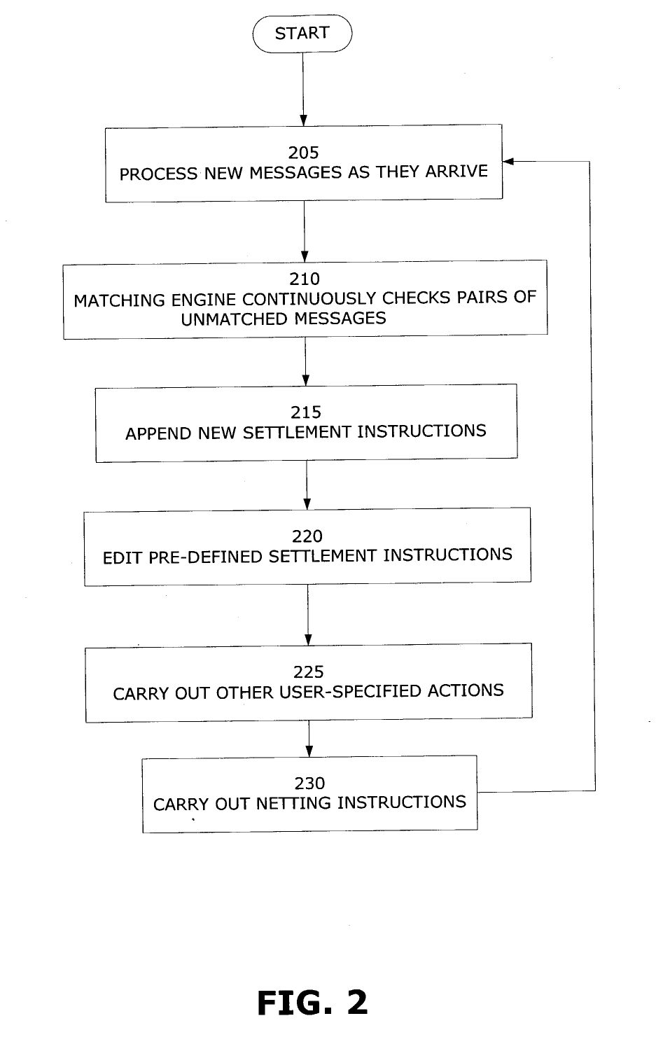

FIG. 2 depicts a high-level flow diagram illustrating the major process associated with practicing the invention. As shown in FIG. 2 at step 205, messages are processed as they arrive into the system, preferably via an online connection over a data communications network, as described above with reference to FIG. 1. A matching subsystem (or matching engine) continuously checks pairs of unmatched messages arriving in the system for potential matches. See step 210. The incoming messages being matched may comprise settlement instructions, confirmations, give-up details, reverse give-up details, etc., from a variety of customers, providers, brokers or funding institutions. All of these messages are processed by the matching subsystem. Next, at step 215, Customers are given an opportunity to append new settlement instructions to the messages, to change existing settlement instructions already contained in the messages, or to select the option of using a standard set of settlement instructions. When the customer appends new settlement instructions or changes existing settlement instructions, the system automatically notifies the counterparty for the transaction. This is a tremendous advantage over the conventional systems.

As shown at step 220, Customers using the present invention can also edit a set of pre-defined or “standard” settlement instructions (SSI), in which case the system automatically updates existing deals using that set of settling instructions. Users of the system may also instruct the system to carry out a variety of other actions (described below) on both matched and unmatched deals. See Step 225. And finally, at step 230, users of the system may specify and negotiate a variety of different types of netting modes available for settling previously-executed transactions. Thus, instead of settling each deal in gross, customers can instruct their banks to make a single payment exchange for deals in the same currency pair or the same currency. Notably, the system may be configured to send notifications of netted payments and receipts to the customer's custodian.

Confirmation Matching

With the present invention, buy-side customers and sell-side banks alike will have the ability to utilize a sophisticated confirmation matching service. In a preferred embodiment, the invention sends and receives SWIFT MT300 confirmations on behalf of customers for trades executed on and off an electronic trading platform. However, other formats for confirmation messages, known to those of skill in the art, also may be used without departing from the scope and spirit of the claimed inventions. The invention acts as a centralized hub for matched and unmatched messages. Thus, customers are able to upload deals to the invention, and download changes in the status of pending financial transactions.

The invention also may be configured to implement several variations on the basic matching process. For example, the customer may choose to manually verify a provider's deal records instead of verifying them online. Thus, the customer may flag a deal record as matched even though the online system has not identified the matching deal record.

Through the invention, customers also have the ability to append settlement instructions from a pre-defined set, or spontaneously for each deal. The additional settlement instructions generate a confirmation message for the provider. If the trade was for a fund, a custodian for the funds is notified. This notification might be accomplished using a SWIFT MT304 message sent over the SWIFT network, for example, or through a file download.

Matching Subsystem Overview

The matching engine in the matching subsystem checks for messages (confirmations) that match in economic and non-economic detail between two parties for executed FX trades. Typically, there are several types of messages that will exist in the matching engine at any point in time: Side A and Side B messages. A Side A message is a message that originates from Party A. A Side B message refers to a message that originates from Party B. Typically, Party A is a customer or client and Party B is a provider bank. However, the matching subsystem also allows providers to match confirmations between themselves. The matching engine may also include Side C messages, which originate from an intermediate party, such as a prime broker. Essentially, the matching engine is the “work-horse” for all messages for all parties. It is a depository of all incoming and outgoing messages for confirmation matching.

Data Structures

In a preferred embodiment, messages are stored outside the matching engine in their original format in a relational database. The relational database is the central place for storing message states and statuses. Side A messages may be uploaded to the relational database via XML (through https), SWIFT (including FIX) or an upload or paste of comma or tab separated files via a user interface. The Side B message usually enters the relational database via a SWIFT message sent from a provider over a SWIFT network interface.

In the preferred embodiment, all messages are converted to MT300 format before being stored in the database. Typically, only a subset of the full MT300 fields are required by the matching engine. Table 1 below shows how certain MT300 fields may be used in an embodiment of the invention:

TABLE 1
MT300 Fields

| Field | MT300 Field | Comments |
|---|---|---|
| Sender's Reference | 20 | |
| Related Reference | 21 | Optional, depends on 22a |
| Type of operation | 22a | Optional, depends on the type of |
| | | operation |
| Party A | 82a | |
| Party B | 87a | |
| Fund or Beneficiary | 83a | |
| Trade Date | 30T | |
| Value Date | 30V | |
| Exchange Rate | 36 | |
| Bought: Currency | Seq B1, 32B | Currency and amount appear on |
| | | the same line |
| Bought: Amount | Seq B1, 32B | Currency and amount appear on |
| | | the same line |
| Delivery Agent | Seq B1, 53a, d, j | The financial institution that the |
| | | payer will transfer the amount |
| Intermediary | Seq B1, 56a, d, j | Intermediary institution for |
| | | transferring funds |
| AC # at Receive | Seq B1, 57a, d | AC # and Agent appear on two |
| Agent | | different lines in the same field |
| Bought: Receiving | Seq B1, 57a, d | AC # and Agent appear on two |
| Agent | | different lines in the same field |
| Sold: Currency | Seq B2, 33b | Currency and amount appear on |
| | | the same line |
| Sold: Amount | Seq B2, 33b | Currency and amount appear on |
| | | the same line |
| Delivery Agent | Seq B2, 53a, d | The financial institution that the |
| | | payer will transfer the amount |
| Intermediary | Seq B2, 56a, d | Intermediary institution for |
| | | transferring funds |
| AC # at Receive | Seq B2, 57a, d | AC # and Agent appear on two |
| Agent | | different lines in the same field |
| Sold: Receiving | Seq B2, 57a, d | AC # and Agent appear on two |
| Agent | | different lines in the same field |

Matching Application Workflows

In a preferred embodiment, the system reads messages from the relational database and assigns a message state to each message for use by a workflow processor (workflow processing engine 142 shown in FIG. 1). The message states may include, for example, the following states: Unmatched, Deferred, Matched, Externally Matched, Virtually Matched, One-Sided Matched, Broken and Cancelled.

Unmatched: An Unmatched message is a new message for which the matching engine is unable to find an appropriate match. The relational database is not updated until the engine changes the match state. Thus, the matching engine will continuously look for an acceptable match for all unmatched messages in the database.

Deferred: In embodiments of the invention, the system may be configured to allow a user to manually link non-matching messages together and indicate which party it believes has sent the incorrect details resulting in the non-matching status. The party believed to be in error can correct its details to complete the match, or reject the requested match.

Matched: A Matched Message is a message that has been marked as Matched by the matching engine or by an end user. Depending on the application and the settings of the particular implementation, a match can occur even when all of the details of two messages do not match. Matched messages may be used immediately for settlement purposes, or placed in an archive for future reference.

Externally Matched: Individual messages may also be marked as externally matched even though they do not fit the formal matching criteria. Typically, users will mark messages as externally matched when they wish to handle the settlement offline using manual methods such as telephones, email and/or faxes.

Virtually Matched: Instead of sending a deal message, one of the parties acknowledges a deal message sent by the other party through some other means, such as by telephone. In preferred embodiments the user can automate the acknowledgement of a Side B message.

One-sided Matched: When the user selects the one sided match option, the user matches the message against itself. This can be done to either a Side A or a Side B message.

Broken: If a match between two messages is broken due to an amendment or cancellation of the deal from either of the parties, the matched messages will be held together as a broken match until all the messages related to the transaction have been updated.

Cancelled: A cancelled deal means that the deal is considered a cancelled state in the relational database. Messages pertaining to cancelled deals are no longer be available for matching, either manually or automatically.

Standard Settlement Instructions (SSI)

Settlement Instructions supplement the economic details of a trade by providing details of which banks accounts the money should be paid from and to. The counterparties must agree on the settlement instructions before the transaction can settle.

Because buy-side customers generally have multiple sets of settlement instructions for each currency, the invention allows users to maintain multiple predefined settlement instructions that may be appended to individual trades at any point in time prior to settlement. A system operating in accordance with the present invention will communicate these instructions to the providers. Customers also have the ability to send to providers ad hoc instruction.

Unlike the economic details, the settlement instructions may change during the life of the transaction. For example, in the time between executing and settling a 1-year forward transaction, a fund manager might decide to use a new fund custodian. The settlement instructions relate to the direct movement of money from one bank to another. Therefore, the invention allows customers to provide new settlement instructions notifying counterparties where money will be sent and received.

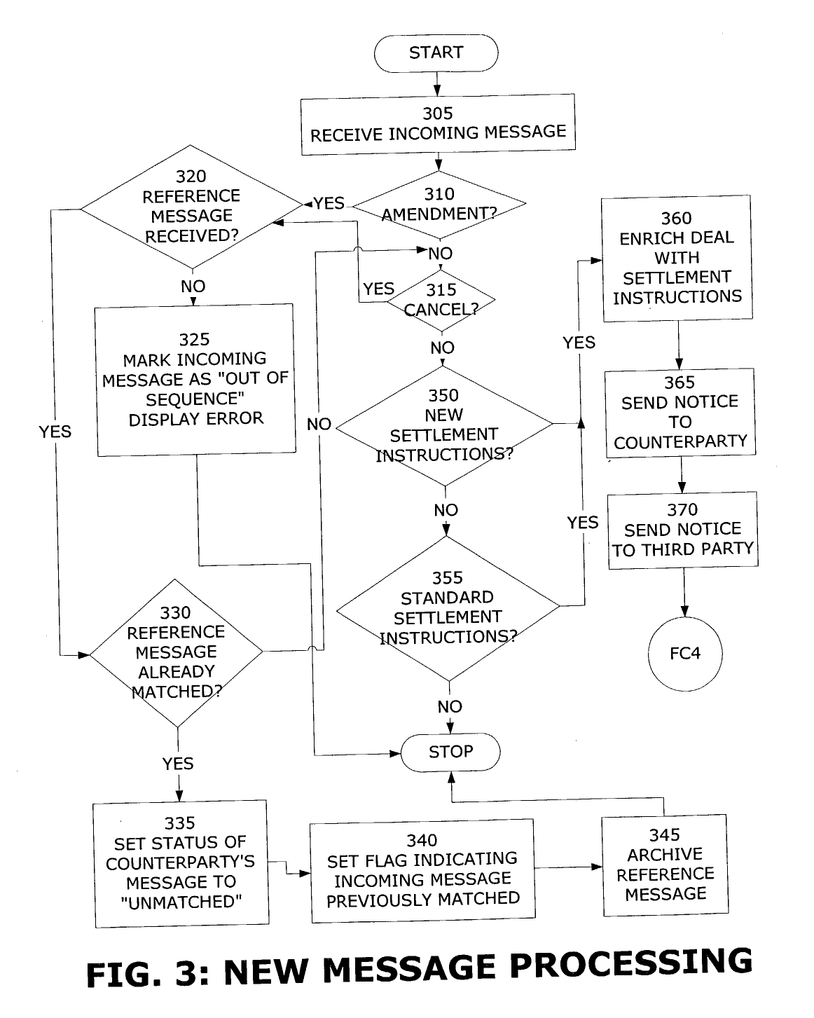

FIGS. 3 through 7 contain a flow diagram illustrating the steps performed by a system operating according to the present invention to implement the confirmation matching and settlement instruction functionality. Beginning at step 305, the system receives an incoming message, usually through an online connection over a data communications network. At step 310, the system checks the message to determine if it is marked as an amendment to an existing message in the system. If the system determines, as shown in steps 320 and 325, that the referenced original message has not yet been received, then the incoming message is marked as “out of sequence” and the message will not be processed further.

If, on the other hand, the system determines (at step 330) that the referenced original message has already been matched, then the status of the incoming message is set to “Unmatched,” and a flag is set to indicate that the “Unmatched” message was previously matched. See steps 335 and 340 in FIG. 3. At this point, step 345, the reference message is archived (since the incoming message is an amendment to the reference message) and removed from the set of active messages in the database.

Returning now to step 310, if the incoming message is not marked as an amendment, the system next determines, at step 315, whether the incoming message has been marked as a cancellation of an existing message. If the answer is yes, then the system determines, at step 320, whether the referenced message has been received. If the referenced original message has not yet been received, the message is marked as “out of sequence” and not processed any further. See step 325. On the other hand, if the referenced original message has already been matched (step 330), then the status of the incoming message is set to “Unmatched,” a flag is set to indicate that the “Unmatched” message was previously matched. See steps 335 and 340 in FIG. 3. Again, at step 345, the incoming message is archived and removed from the set of active messages in the database.

At step 350, the system determines whether the message contains settlement instructions. If the message does not contain settlement instructions, the system then checks whether the user has configured the system so that deals for this counterparty, currency pair, account and tenor should be instructed for net settlement. If so, the message is enriched with payment and receipt instructions for net settlement. See step 360. If the deal is not going netted, the system checks, at step 355, whether the user has defined a set of default Standard Settlement Instructions (SSI) for the receipt currency and account. If so, the message is enriched (step 360) with the receiving agent, intermediary, and other information for the receipt currency

If the counterparty wishes to receive notification immediately upon arrival of a new message, an MT300 notification is sent to the counterparty. Step 365. In preferred embodiments, the message type is also matched at this point (new, amend, cancel) and settlement information may be included in the message. If a third-party of the message sender wishes to receive notification immediately whenever a new message arrives, or if this is a cancellation, an MT304 notification is sent (see step 370). The message type (new, amend, cancel) of the message received is matched. For new and amendment messages, the outgoing message is enriched with the following instructions, if possible:

Counterparty's receiving agent and intermediary for the payment currency

Customer's delivery agent for the payment currency

Counterparty's delivery agent for the receipt currency

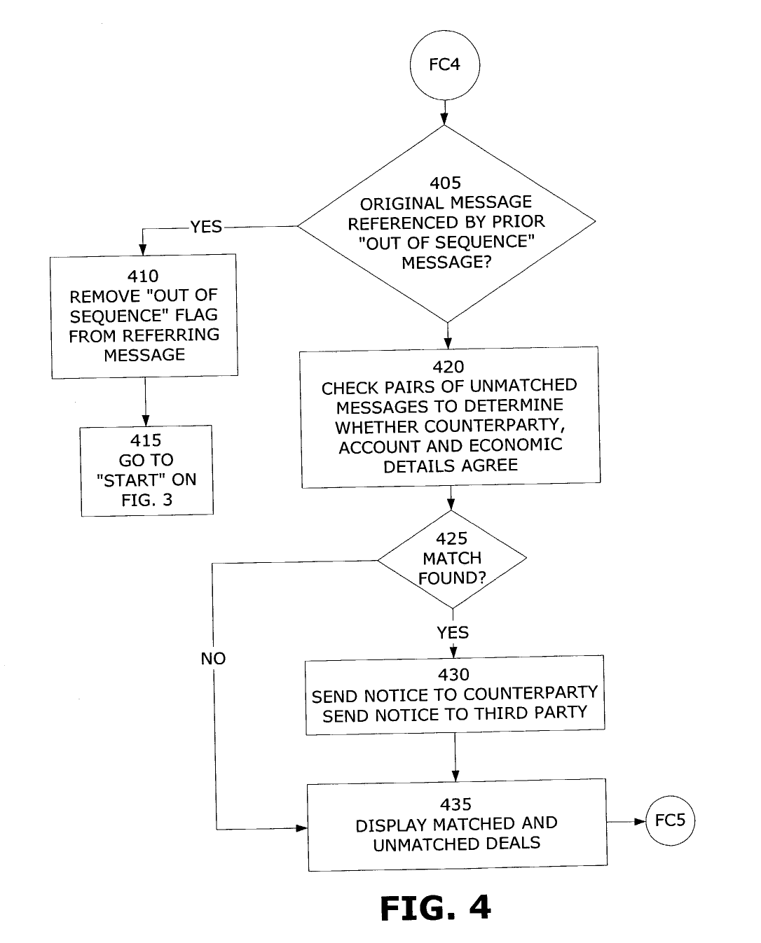

At this point, processing continues at step 405 in the flow chart shown in FIG. 4 by way of flow chart connector FC4. In step 405, the system determines whether the incoming message is the original message for a message earlier received out of sequence. If the answer is yes, the out of sequence flag is removed from the referring message. See step 410, and, at step 415, processing returns to “Start” in FIG. 3 so that the message may be processed as if it were a new message.

Next, at step 420, the matching engine checks pairs of unmatched messages to determine whether counterparty, account and economic details agree. Note that, in preferred embodiments, the system maintains a list of message-pairs that are not allowed to match. If a match is found at step 425, an MT300 notification is sent to counterparties and third parties who wish to be notified (step 430) and the matched pairs and unmatched pairs are displayed, step 435. If a match is not found, the notification step 430 is skipped and the system goes directly to step 435.

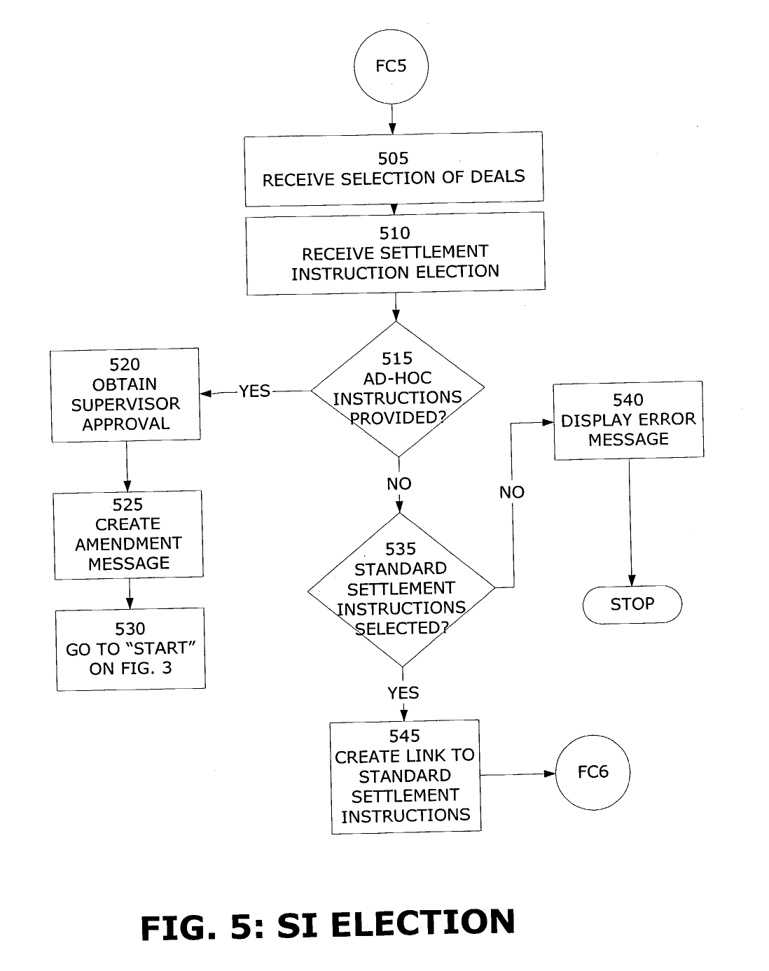

By way of flow chart connector FC5, processing continues at step 505 of FIG. 5, wherein the system receives from the user a settlement instruction selection (step 510). In practice, the Customer selects a deal, either matched or unmatched, and then selects whether to add/change the settlement instructions. If the customer provides ad hoc instructions, step 515, supervisor approval is obtained (step 520), an amendment message is created (step 525) and, as illustrated by step 530, processing returns to the beginning of the process (the “Start” point on FIG. 3). If, during step 535, the system determines that the standard settlement instructions are selected, a link between the trade and the settlement instruction selection is created (step 545). This way, if the settlement instructions are subsequently edited, the trade can be automatically updated. If SSI is not selected in step 535, then an error message is displayed in step 540.

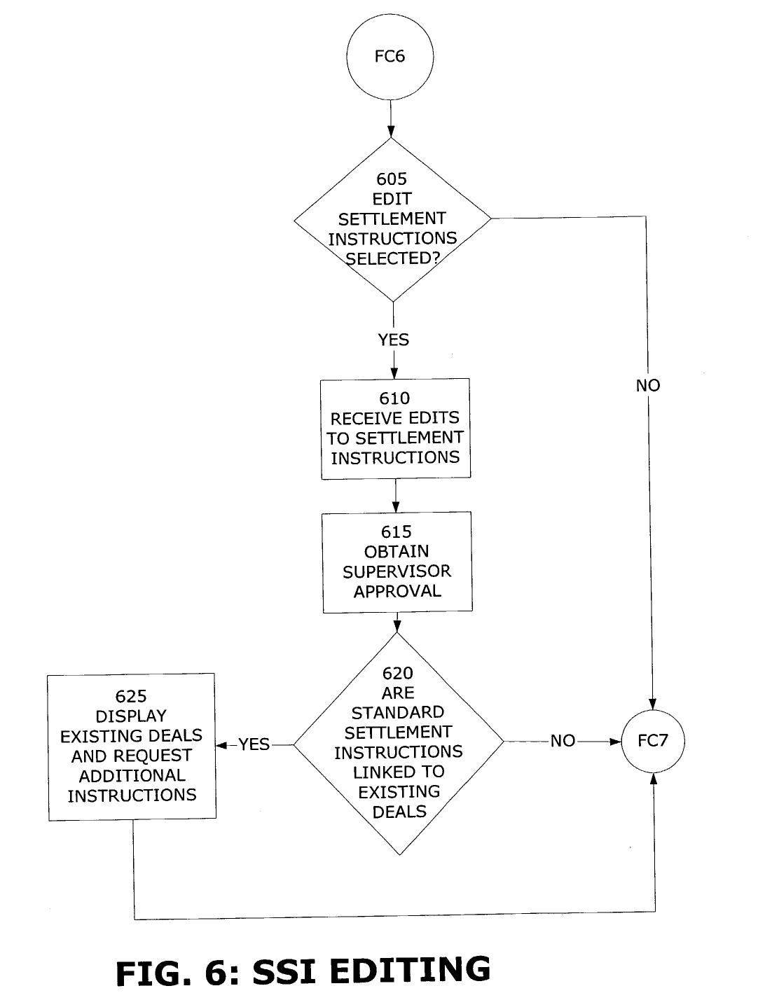

Processing now continues at step 605 of FIG. 6 by way of flow chart connector FC6, where the system determines whether an instruction indicating that the user has selected SSI editing has been received. If so, the settlement instruction edits are received from the Customer in step 610. Next, at step 615, supervisor approval is obtained. If any existing deals are linked to the SSI, the system displays the existing deals and prompts the user for additional instructions (steps 620 and 625). Typically, the user has three options:

Update the deal record, send an amendment message to the counterparty (and custodian if one has been set up for the account).

Update the deal, but do not send any amendment messages. In this case, it is anticipated that the customer will advise the counterparty and custodian outside of the system.

Do not update the deal. This is intended for situations where the change in SSI affects new deals only, but existing deals will settle as previously agreed.

Other User Actions

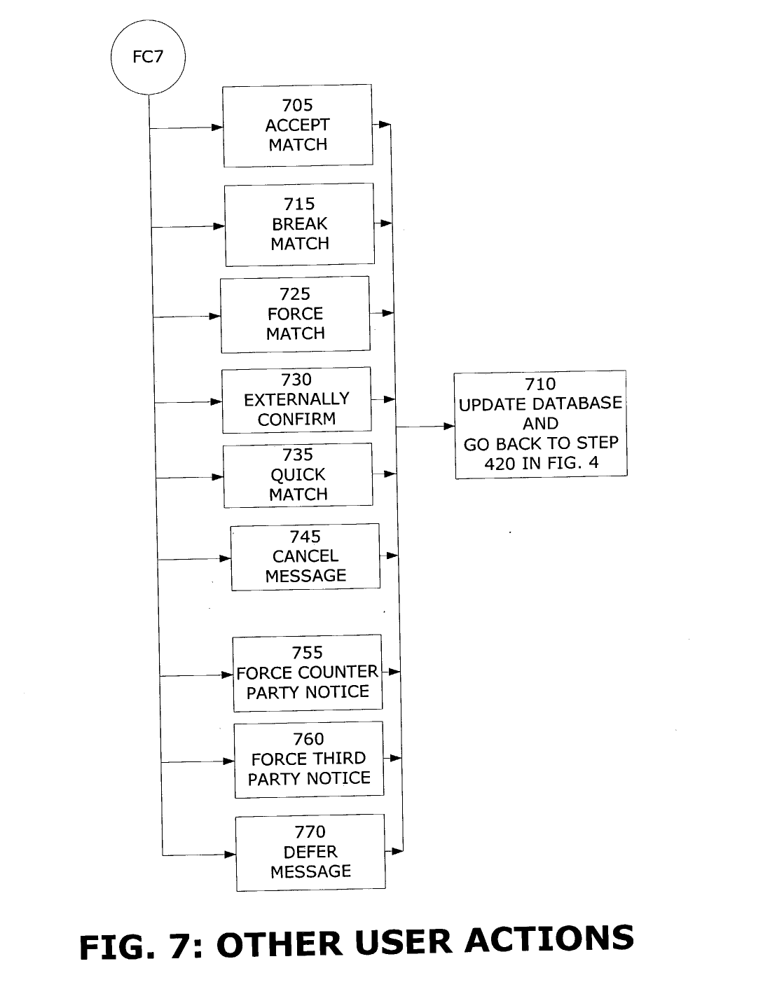

Processing then continues, by way of flow chart connector FC7, to any one of the user actions shown in FIG. 7. As shown in FIG. 7, there are several other actions the user may take at this point. The user can accept the match, as shown in step 705. But the user can also select a matched deal and manually ‘break’ the match. See 715 in FIG. 7. The matched messages revert to unmatched status and therefore can be re-matched by the matching engine. However, the pair of messages is added to the matching engine's exception list so that the matching engine will not subsequently match these messages with each other.

Force Match. At step 725, the user can manually select two unmatched messages that agree on counterparties and account, but disagree on one or more economic details and/or settlement details. The user can then manually instruct the system that the messages should be ‘matched’ with each other. The pair of messages is then processed as if the matching engine had processed them automatically.

Externally Confirm. At step 730, the user may indicate that an unmatched message has been confirmed outside the system. The message is flagged as matched and therefore the matching engine will not subsequently attempt to match the message. The single message is then processed as if the matching engine had matched it with another message.

Quick Match. At step 735, the user can select an unmatched message and cause the system to create a mirror-image message, as if the counterparty had sent a confirming message. The system then Force Matches the message with the mirror-image message and processes it as described above.

Cancel Message. At step 745, the user can cancel a message using a user interface. This is equivalent to sending the system a cancellation message.

Force MT300. In situations where an MT300 has not yet been sent for a customer message, the customer can instruct system, at step 755, to send an MT300 message immediately.

Force MT304. In situations where an MT304 message has not yet been sent for a customer message, the customer can instruct the system, at step 760, to send the message immediately.

Defer Message. If, at step 770, the system receives a “defer message” signal, the message is flagged for subsequent amendment or cancellation. This is simply an informational flag—it has no impact on the behaviour of the message in the matching engine.

Upon completion of any of these user actions, the system then updates the database and processing then returns to the matching step, which is step 420 in FIG. 4.

Netting

Netting allows counterparties to combine multiple payments arising from different transactions into a single, equivalent payment. This simplifies the settlement process and reduces costs. Netting is usually carried out shortly before settlement, typically one-day prior to the settlement date.

The mechanics of the netting process are typically defined by a netting agreement between the two counterparties. A typical process is for the two counterparties to review cash flows for the same bank account on the same date and agree to exchange only a net payment. Note that the underlying deals that generated the scheduled payments may have been executed on different dates. Once the payment amounts has been agreed, any new trades must be settled separately, or the initial net must be undone. If there are several such trades, they can likewise be netted together into a single payment, but the original netted payment remains unchanged.

In the existing systems, netting agreements are usually arranged by telephone or fax. By using the invention, however, customers can specify a value date and a set of accounts and view a set of netted payments calculated for that value date based on a selected currency or currency pair. Once the customer is satisfied with the calculated settlement amounts, a system operating in accordance with the present invention submits the netted payments to the counterparty banks for approval.

As stated above, there are at least two types of netting available with the invention: bilateral and multilateral netting. In bilateral netting, currencies are netted in the same currency between two parties. In multilateral netting, all currency pairs are netted down to single currency. Suppose for example, the trades shown in Table 3 below have executed.

TABLE 3
Executed Trades

| | | Trade | | | | | |
|---|---|---|---|---|---|---|---|
| Reference | Account | Date | Pair | Buy | Buy Amt | Rate | Sell Amt |
| 123456 | TACCT1 | Mar. 27, 2002 | EUR | CHF | 3,641,965.00 | 1.476328 | 2,466,907.76 |
| | | | CHF | | | | |
| 123457 | TACCT1 | Mar. 27, 2002 | EUR | EUR | 989,708.58 | 1.480553 | 1,465,316.01 |
| | | | CHF | | | | |
| 123458 | TACCT1 | Mar. 20, 2002 | EUR | NOK | 3,641,965.00 | 8.01 | 454,677.28 |
| | | | NOK | | | | |
| 123459 | TACCT1 | May 20, 2002 | EUR | EUR | 584,361.51 | 8.016695 | 4,684,648.00 |
| | | | NOK | | | | |
| 123450 | TACCT1 | May 15, 2002 | EUR | GBP | 6,546,546.00 | 0.610026 | 10,731,585.21 |
| | | | GBP | | | | |
| 123458 | TACCT1 | Mar. 20, 2002 | EUR | EUR | 105,907,243.77 | 0.619926 | 65,654,654.00 |
| | | | GBP | | | | |
| 123459 | TACCT1 | May 15, 2002 | EUR | PLN | 6,468,464.00 | 42.4546 | 152,361.91 |
| | | | PLN | | | | |
| 123458 | TACCT1 | May 20, 2002 | EUR | EUR | 153,692.94 | 42.59497 | 6,546,546.00 |
| | | | PLN | | | | |

Bilateral netting against the EUR currency would yield the following result:

| BUY | | SELL | |
|---|---|---|---|
| CCY | AMOUNT | CCY | AMOUNT |
| CHF | 2,176,648.99 | EUR | 1,477,199.18 |
| EUR | 129,684.23 | NOK | 1,042,683.00 |
| EUR | 95,175,658.56 | GBP | 59,108,108.00 |
| PLN | 1,331.02 | EUR | 78.082.00 |

Multilateral netting would yield the following results:

| CCY | RECEIVE | PAY |
|---|---|---|
| EUR | 93,829,474.64 | 0 |
| CHF | 2,176,648.99 | 0 |
| NOK | 0 | 1,042,683.00 |
| GBP | 0 | 59,108,108.00 |
| PLN | 0 | 78,082.00 |

Once a set of netted payments has been calculated, the user will be given the opportunity to send the results to the provider for approval. Upon approval the provider will typically send a message back to the user confirming acceptance of the proposed netted settlement payments. At any time, the customer may break the netted payments agreement as long as the provider accepts the request.

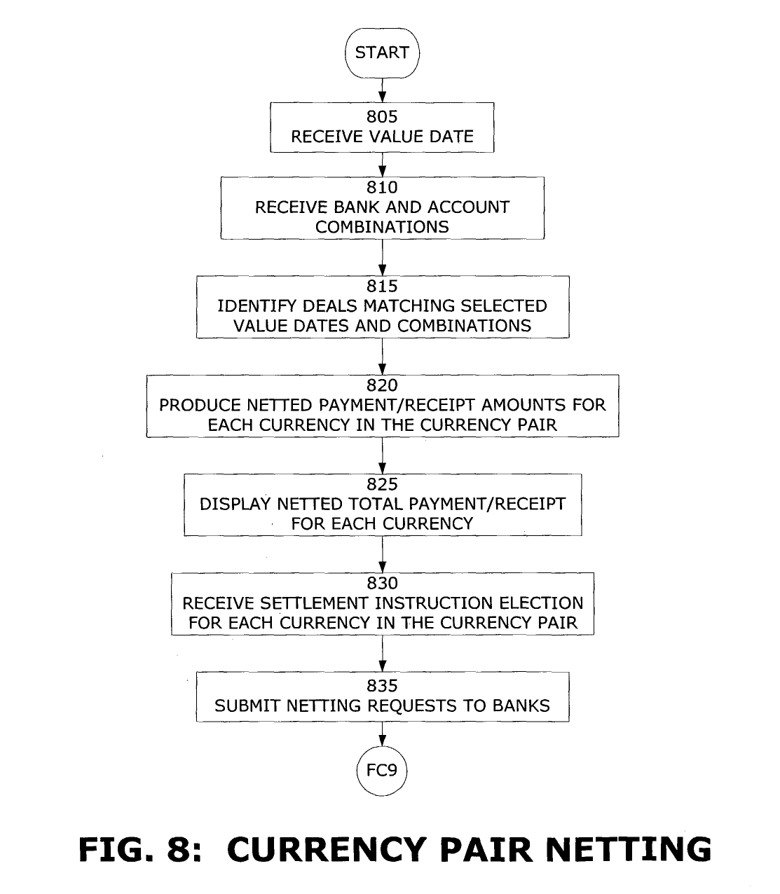

FIG. 8 illustrates the steps that might be performed in an embodiment of the present invention to implement currency pair netting. In currency pair netting, the object is to combine all deals in the same currency pair into a single exchange of payments for each bank and account traded. Currency pair netting allows the customer to identify the settlement instructions for each currency the customer will be receiving.

First, as shown in step 805, the Customer provides, and the system receives, a value date for which to calculate net settlements. Next, in step 810, the Customer selects and the system receives one or more combinations of banks and accounts for which to calculate net settlements. Thus, the Customer has flexibility in managing the netting process. At one extreme, the customer can process the net settlements for all banks and accounts in a single step. At the other extreme, the customer can process the net settlements for just a single bank and account combination. Once the details for the bank and account have been agreed to, the customer may process additional combinations in successive steps. The customer may process all the accounts traded with a single bank, and then move onto the next bank, or the customer can elect to process the payments account by account.

The invention identifies messages matching the selected value date, bank and account criteria. See step 815. For each currency pair traded, the system nets together the payments and receipts for each currency, producing (at step 820) a netted payment/receipt amount in each of the two currencies. For each currency pair, the system may be configured to display, as shown in step 825, the netted total payment/receipt for each currency. The system can also provide a listing of the deals contributing to the net amount. The customer is able to exclude deals from the net (that is, to have them settled in gross rather than included in the net totals). In this case, the system provides the adjusted total, and lists both the deal(s) excluded from the net and those included in the net.

As an aid for instructing the customer that the netted totals are correct, the customer may request that the system further net the currency pairs across banks, across accounts, or both. This additional functionality can be extremely useful, for example, when the customer knows that the net cash flow across all banks for a given account is zero. In other words, while there may be payments or receipts to individual banks (each of these being the net of multiple transactions), overall the net total is zero. By using the present invention to net currency pairs across banks and/or across accounts, the customer may be reassured that the amounts are correct.

For each currency within each netted currency pair where the customer will be receiving funds, the customer can select from a set of pre-defined settlement instructions for that currency and account. The selection is received by the system in step 830. Alternatively, the customer can leave the settlement instructions blank in order to provide instructions to the bank though an alternative method, such as by fax or telephone, or another online transaction system.

For each currency within each excluded deal where the customer will be receiving funds, the customer can select from the pre-defined settlement instructions for that currency and account. Alternatively, the customer can leave the settlement instructions blank. In this case, the customer can provide settlement instructions to the bank either (1) subsequent to the netting process by using the non-netting functionality of the invention for attaching settlement instructions to gross-settled deals, or (2) externally via alternative manual methods.

After the customer has checked the amounts and added any desired settlement instructions, the requests are submitted to the bank in step 835. Typically, although not necessarily, the requests are submitted to the banks as follows: For each bank and account combination containing deals to be netted, a separate netting request is sent. Each request contains the netted amounts for each currency pair and the underlying deals contributing to the netted amounts. Each deal that was excluded from the net and had settlement instructions attached by the customer is processed using the invention's procedure for changing the settlement instructions on a gross-settled deal. In other words, the change is processed as a deal amendment (see New Message). No action is taken for deals that were excluded from the net and did not have settlement instructions attached.

While each bank is reviewing the information submitted, the customer may continue the netting process for any remaining accounts/banks. This is because the system allows the customer to carry out all netting in one process or to break it into multiple processes. Usually, each netting request will be reviewed separately by the receiving bank. The bank looks at the net totals and can further drill-down to review the underlying deals.

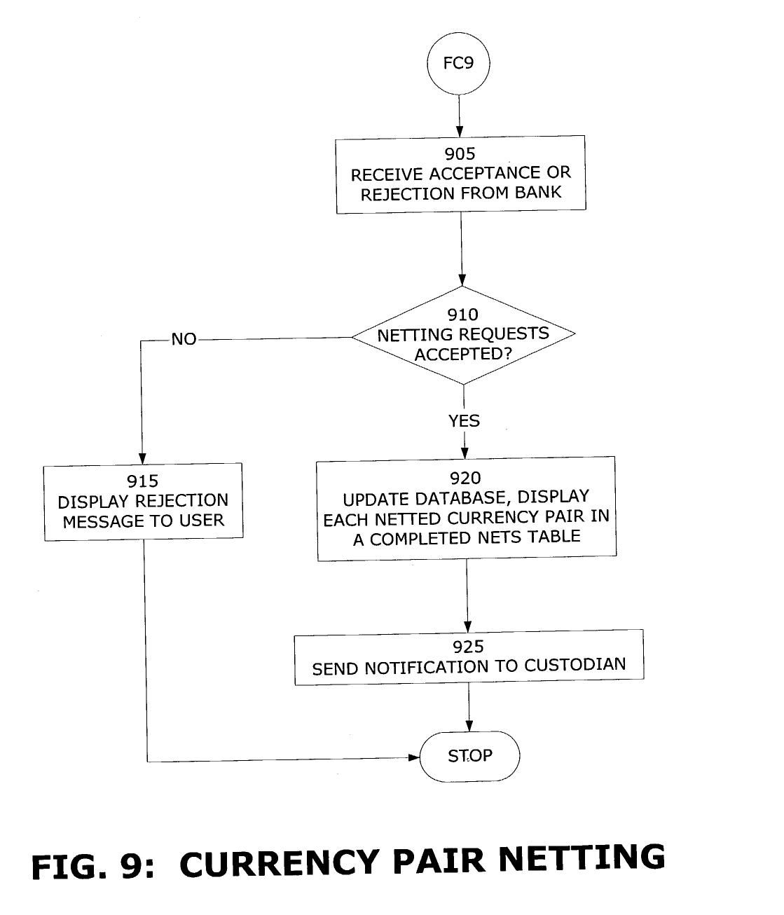

Continuing at step 905 in FIG. 9 by way of flow chart connector FC9, each netting request must either be accepted or rejected in its entirety by the bank. If the system determines, at step 910, that the bank accepted a netting request, the system is updated to show that the underlying deals will now be settled by netting (step 920). Preferably, each netted currency pair is displayed to the user in a ‘completed nets’ table to show the agreed settlement amounts. Optionally, the system can be configured to notify the custodian of the funds of the agreed settlement amounts (step 925). Thus, the invention may be configured to send a notification message to the custodian using industry standard SWIFT messaging. Whereas for individual FX deals, an MT304 message is sent to the custodian, for payments/receipts two additional messages are used: An MT202 message is sent to advise the custodian to make a payment to the bank. An MT210 message is sent to advise the custodian of a receipt to be expected from the bank.

If it is determined at step 910 that the bank rejected a netting request, the system returns the netting request to the customer as rejected and displays an error message. See step 915. It is expected that the two parties will resolve the problem using the telephone or alternative method. The customer can subsequently re-open a netting request and adjust it, provided that the bank agrees to do so. Typically, there are three changes possible: The customer may remove deals previously included in the net so that they can be settled gross, add deals previously marked for gross settlement back into the net, or change settlement instructions for a netted receivable. Once these changes are made, the customer can resubmit the netting request to the bank.

Currency Netting

In currency netting, the goals are to combine all payments in the same currency into a single net payment, for each bank and account traded, and to allow the customer to identify its settlement instructions to the bank for each currency the customer will receive. The process for implementing currency netting is almost identical to currency pair netting, except that each FX deal is treated as two independent payments, one from the customer to the bank, the other from the bank to the customer. Within a particular bank and account combination, these payments are then netted together, even if the original deals were for different currency pairs. For example, if the customer had three EUR-USD deals and three USD-JPY deals, then, with currency pair netting, the system would produce a single EUR-USD settlement payment and a single USD-JPY settlement. However, when the system is instructed to use currency netting, the system would produce a single USD settlement (across the six deals), a single EUR settlement and a single JPY settlement.

Multi-Lateral Currency Netting

The goal in multi-lateral currency netting can be stated as follows: For a given currency and account combination, to have the banks that the customer expects payment from directly pay those banks that are expecting payment from the customer. Customers can use this settlement technique for those currencies where their trading strategy dictates that they will have a net balance of zero (and use original, or bilateral, currency netting for the remaining currencies). For example, a customer may need to buy and sell NOK to cover business expenses and receipts but have no NOK balance account. So the net NOK cash flow for the customer must always be zero.

First, the Customer selects a value date for which to calculate net settlements. The Customer also selects one or more accounts for which to calculate net settlements. Note that unlike the previous netting techniques, multilateral netting involves multiple banks simultaneously. Therefore, for a given account, the bank approvals must be processed simultaneously.

In preferred embodiments, the system is configured to maintain administrative settings, such as through a user profile, for example, which indicates to the system which currencies should be settled using multilateral currency netting and which currencies should be settled using bilateral currency netting. For those currencies to be multilaterally netted, the system provides the net total across all banks, the number of banks involved, and the number of deals involved. For those currencies to be bilaterally netted, the system provides the amount to be paid to for each bank and the number of deals underlying each net payment.

As with the other netting techniques, the customer is able to exclude deals from the netting process. Also as with the other netting techniques, the system adjusts the net totals as deals are excluded and lists the excluded deals. Customers are able to add an excluded deals back into the net at this point. Customers can also switch individual currencies between bilateral and multilateral netting. Switching a currency from bilateral netting to multilateral netting results in the net amount listed out by bank to be replaced by a net amount across all banks as described above. Similarly, switching a currency from multilateral netting to bilateral netting results in the net amount across all banks be replaced by a net amount for each bank

Prime Brokerage Functions

A more detailed description of the prime brokerage functionality of the present invention will now be provided. In the following descriptions and examples, the Customer is a buy-side participant who wishes to engage in a financial transaction with a liquidity provider using the services of a prime broker. The prime broker, typically a bank or other financial institution, is the intermediary that takes on the Customer's credit risk. The Executing Bank is the bank that takes the market risk on the deal. The Funding Bank is the bank holding the physical accounts for one of the funds traded by the Customer.

There are three phases associated with the prime brokerage function: Execution, Give Up and Reverse Give-Up.

Execution Phase

In the Execution Phase, the Customer and the Executing Bank complete an FX transaction with an understanding that the Prime Broker will be prime brokering the trade. The Executing Bank provisionally books the trade but with the Prime Broker as the counterparty. The Customer provisionally books the trade, but with the Prime Broker as the counterparty. Depending on the Prime Broker's billing model, the Customer may book a deal at a slightly different rate than that agreed between the Customer and Executing Bank. The Customer and the Executing Bank both send details to the Prime Broker.

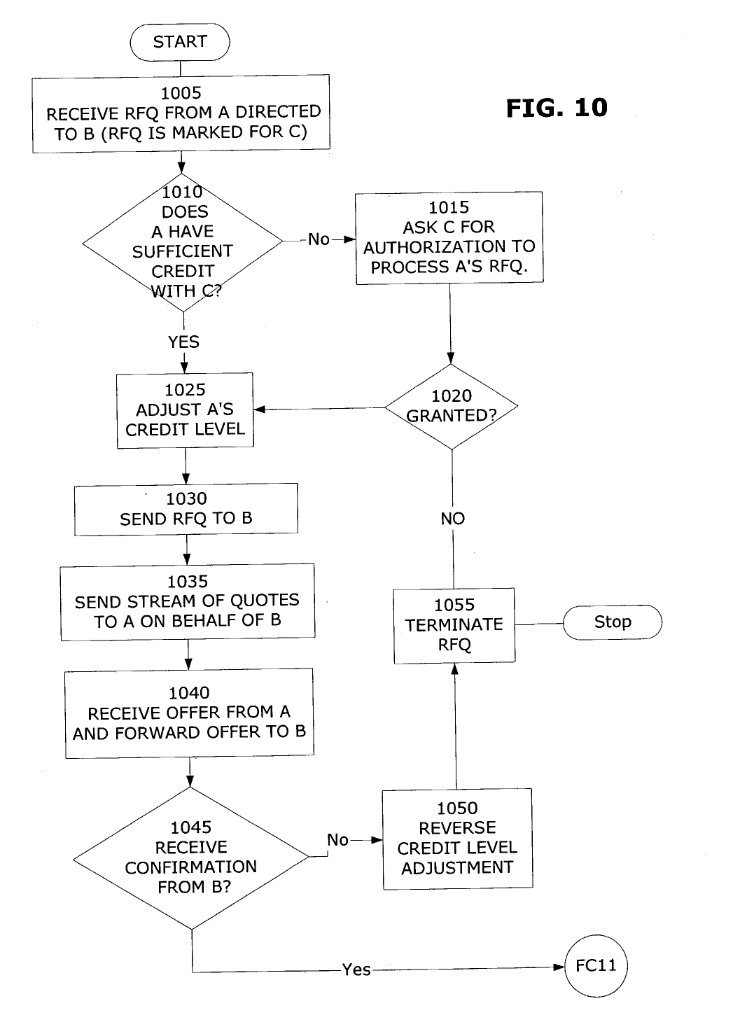

FIGS. 10, 11 and 12 contain a flow diagram illustrating the steps that might be performed to implement this aspect of the invention. In this example, Party A is the Customer, Party B is the Executing Bank, and Party C is the Prime Broker. Beginning at step 1005 in FIG. 10, the system receives an RFQ from Party A. The RFQ is marked for using C as the Prime Broker. The system supports multiple dealing protocols for initiating transactions and any one of them may be used, depending on the trade execution system. The following list provides a few examples of the various protocols that may be used:

Request for Quote: Using this protocol, the Executing Bank returns one or more prices to the Customer and the Customer chooses whether to accept Executing Bank's current price.

At Best: Under this protocol, the Executing Bank executes the Customer's request at the current market level, and informs the Customer post-trade of the execution rate.

Kill Or Fill: With this protocol, the Customer provides the Executing Bank with a worst acceptable rate. The Executing Bank immediately either completes the deal at this rate (or better) or informs the customer that no execution is possible

Resting Order: Here, the Customer providers the Executing Bank with a worst acceptable rate. The Executing Bank completes the deal as soon as the market is trading at this rate (or better). The Customer may cancel the order at any time prior to execution.

At Fix: With this protocol, the Customer and the Executing Bank agree on a third-party reference rate to use for the execution (e.g. Fxall Inc.'s Indicative Quote at 5 p.m.).

Any of these protocols, as well as others, may be agreed between the counterparties.

With the present invention, the Customer may combine a Prime Brokerage deal and a non-Prime Brokerage deal into a single execution. Notably, the Customer's request can be checked against the agreement between the Customer and the Prime Broker (for credit limit, currency pairs allowed, maximum forward date allowed, etc) before RFQ is sent to Executing Bank. Normally, both Customer's name and the Prime Broker's name would be presented to the Executing Bank at deal request time. However, the Customer can elect to hide his identity.

The Prime Broker may agree with the Customer that every execution will be marked-up (that is the Customer executes with the Prime Broker at a slightly worse rate than that between the Customer and Executing Bank). This provides a per-deal fee for the Prime Broker. The invention will automatically calculate the Customer's execution rate. As an alternative, the Prime Broker may decide not to markup individual but to send periodic invoices. In this case, the invention can track the deals traded and calculate a periodic bill based on their currency pairs, volume and maturity dates.

Returning to FIG. 10, before submitting the RFQ to the Party B (the Executing Bank), the system determines, at step 1010, whether the Party A (the Customer) has sufficient credit with the Party C (the Prime Broker) to initiate the requested transaction. Usually, this involves checking a set of credit rules provided by the Party C. If it is determined, at step 1010, that A's credit is okay, then A's credit is adjusted to account for the requested transaction (see step 1025). If, on the other hand, the credit rules applicable to A do not authorize A to initiate the transaction, the system sends a message to C asking C for authorization to proceed with the transaction (step 1015). If C grants the authorization (step 1020), then A's credit is adjusted (step 1025) and the RFQ is sent to the Party B (the Executing Bank) at step 1030. But if C denies the authorization, the RFQ is terminated (step 1055) and the processing ends.

Next, at step 1035, the system sends a stream of quotes A on behalf of B. If A responds to the stream of quotes by providing an offer to deal, the system forwards the offer to deal to B (step 1040). At step 1045, the system determines whether B has accepted A's offer to deal by sending a confirmation message. If the system does not receive a confirmation from B, or receives a rejection from B, then the credit level adjustment applied to A's account in step 1025 is reversed (step 1050), the RFQ is terminated (step 1055) and processing stops.

Give-Up Phase

In the Give-Up Phase, the Prime Broker checks that the details received are consistent. The Prime Broker books the two deals identified in the execution phase—one with the customer, the other with the Executing Bank. The Prime Broker notifies the Executing Bank and the Customer that the give-up has been accepted, finalizing the provisional bookings.

Continuing the example, if the system receives a confirmation from B at step 1045 of FIG. 10, processing continues at step 1105 by way of flow chart connector FC11, where the system checks to see if it has received new or amended give-up details from the Party A. If the answer is yes, then, at step 1110, the system forwards A's give-up details to C and provisionally books a deal between A and C. Then the system checks to see if new or amended give-up details have been received from Party B (step 1115). Note that if Party A's give-up details have not been received in step 1105, the system goes directly to checking on whether Party B's give-up details have been received (see step 1115). If Party B's give-up details have been received at step 1115, Party B's give-up details are forwarded to Party C and the system provisionally books a deal between B and C. Notably, the deal between Party A and C may be at a higher rate than the rate for the deal between B and C.

Next, at step 1125, the system determines whether give-up details have been received from both A and B. If not, the system goes into a loop (comprising steps 1105, 1110, 1115, 1120 and 1125) until both sets of details have been received. When both sets of details are received, the system informs all parties of the match state for the give-up details (step 1130). The match state is provided by the matching engine, which is always continuously checking pairs of messages in the message database for matches in the background.

Next, the system determines whether a message has been received from C to accept the give-up (step 1140). If not, then the system checks to see if C has sent a rejection of the give-up (step 1145). If there's been no acceptance or rejection from C, the system again checks to see if A or B have sent any amendments for the give-up details by returning to step 1105. If there has been no acceptance or rejection, and no amendments, then the system loops back to step 1130, where the system again informs the parties of the match status. In other words, the system loops until C accepts or rejects the give-up, which gives A and B a chance to provide any amendments.

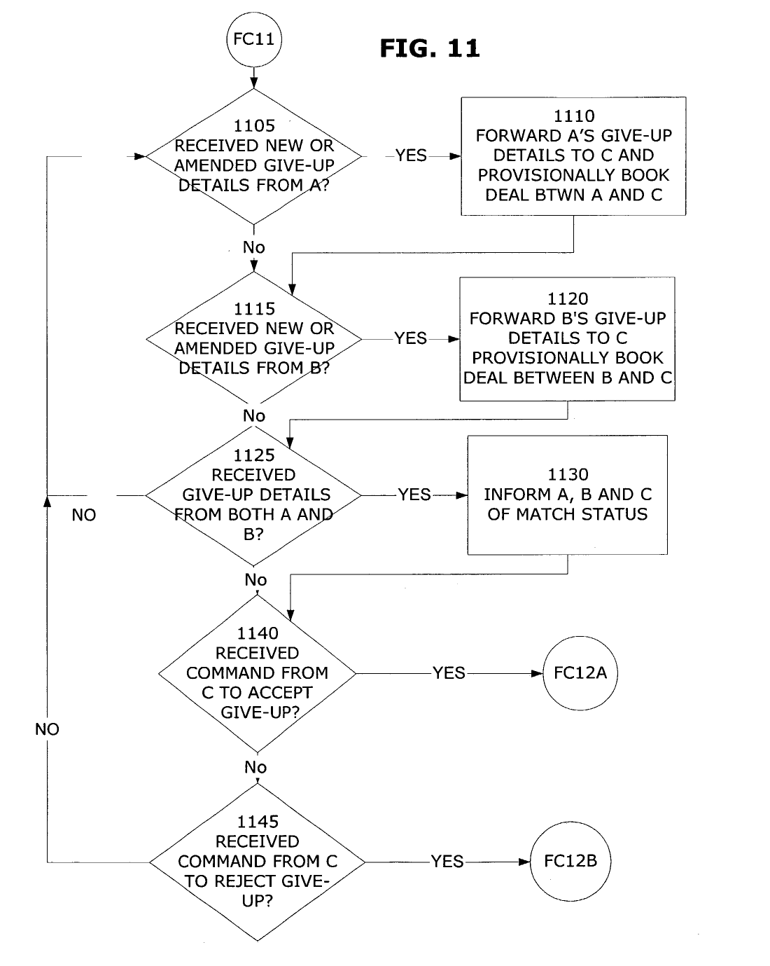

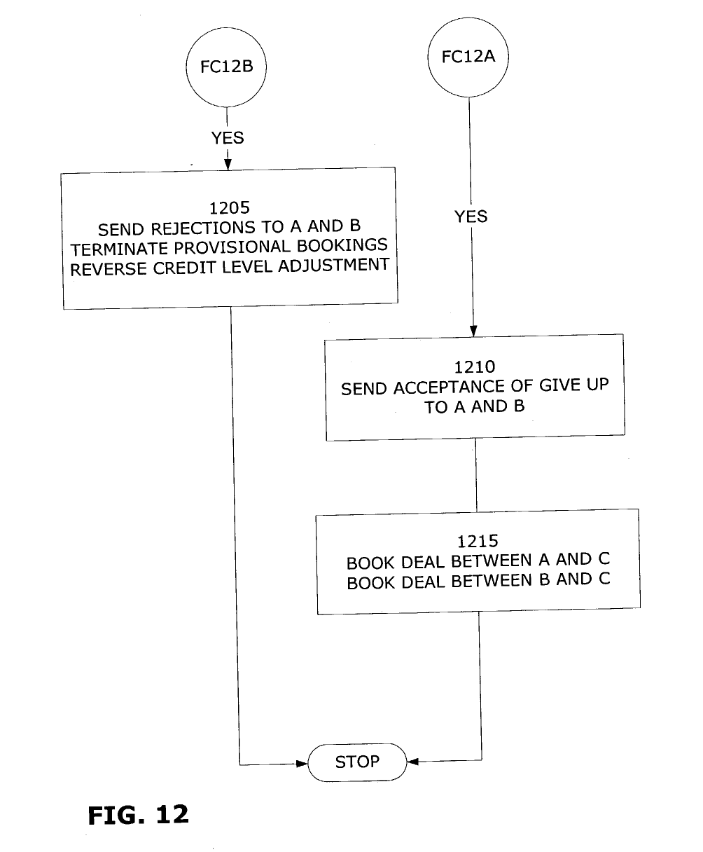

If it is determined at step 1140 that C sent an acceptance, then processing continues at step 1210 of FIG. 12, by way of flow chart connector FC12A, where the system sends a message to A and B that C has accepted the give-up. Then the system books the deal between A and C, as well as the deal between B and C, on a non-provisional basis (step 1215). At this point processing of the RFQ is complete. If it is determined at step 1145 of FIG. 11, that C sent a rejection instead of an acceptance, then, then processing continues at step 1205 of FIG. 12, by way of flow chart connector FC12B. Here, the system sends rejection notices to A and B, terminates the provisional bookings, reverses the credit level adjustment performed at step 1025 of FIG. 10, and terminates processing.

At the Customer's discretion, messages from the Executing Bank may be ‘withheld’ from delivery to the Prime Broker until the corresponding message is received from C. This allows for the Customer to control when its execution details are released to the Prime Broker. Using the invention, the Customer is able to view messages sent by the Executing Bank to the Prime Broker relating to deals between the Customer and Executing Bank. Similarly, the Executing Bank can view messages sent by the Customer related to deals between the Customer and the Executing Bank.

As stated above, the invention can optionally automatically notify the Customer and the Executing Bank when consistent economic details have been sent to the Prime Broker. The Prime Broker checks that the deal is within Customer's agreement with the Prime Broker (for credit limit, currency pairs allowed, maximum forward date, etc). As described above, the invention may be configured to carry out this step as part of the RFQ or execution process.

Reverse Give-Up Phase

The Customer may ask the Prime Broker to split the deal into transactions over several funds. This is called the Reverse Give-Up phase. These transactions net to the amount given-up to the Prime Broker. For each transaction, the Customer may ask the Prime Broker to adjust the value date, resulting in a price change for that transaction. The Prime Broker cancels its original deal with the Customer. For each transaction, the Prime Broker books a trade with the appropriate Funding Bank. The Customer records details of each transaction although it plays no part in the settlement of these transactions. For each reverse give-up, the Funding Bank is notified of the details. For each reverse give-up, the Funding Bank books the transaction details and confirms these details back to the Customer. For each reverse give-up, the Customer checks that the details confirmed by the Funding Bank are correct

The amount given up to the Prime Broker may need to be split across several different bank accounts. These accounts may be held at multiple third-party banks. For each split, the Customer may want to change the value date of the deal between the Customer and the Prime Broker. A common practice is for customers needing FX forwards to execute at FX spot deal with Executing Bank, give up the deal to the Prime Broker, and then agree the FX forward points with the Prime Broker.

Using an online post-execution system, such as Fxall, Inc.'s Operations Center, or otherwise, the Customer informs the Prime Broker of the breakdown of the ‘block’ amount given-up into a set of accounts traded by C. For each split, the Customer identifies the fund, the amount and the required value date. For any split requiring a value date change, using Operations Center, or otherwise, the Prime Broker quotes the Customer the FX Forward Points for that value date (the forward points are the change in price as the deal is moved from the spot date to the desired forward date). The Customer agrees to the forward points for each split.

The Customer and the Prime Broker then each cancel the original ‘block’ deal. For each split, the Prime Broker books a separate deal with the appropriate Funding Bank reflecting the account, amount, value date, and new price. The Customer makes a note of each split, although it plays no part in the settlement of these deals. Next, using the invention or otherwise, for each fund, the Prime Broker sends a notification to the Funding Bank identifying the deal details. Using the present invention, this step can be automated—as soon as the Funds Breakout is agreed between the Customer and the Prime Broker, the invention will send the notifications to the Fund Banks.

The Funding Bank books the transaction as directed by the Prime Broker. Using the present invention or otherwise, the Funding Bank sends a confirmation message to the Customer with the booking details. The Customer checks the booking details its has agreed with the Prime Broker against those sent by Funding Bank. Using the present invention, this checking occurs automatically.

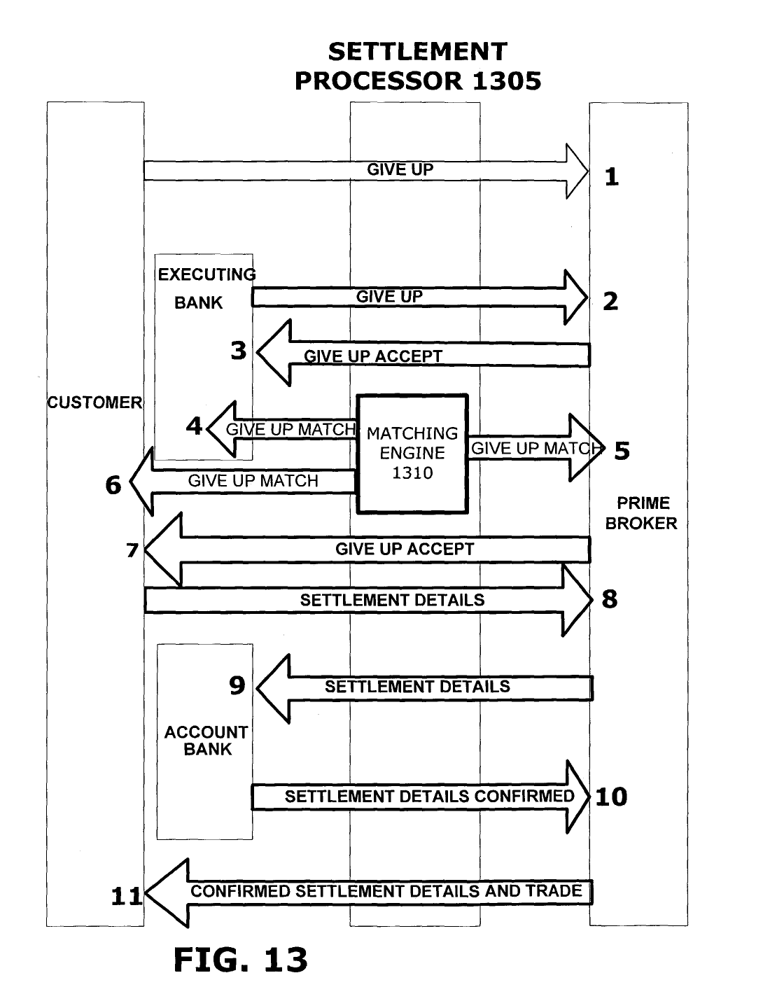

FIG. 13 contains a high-level block diagram illustrating message flows in a transaction system configured in accordance with the present invention, to implement the prime brokerage functionality. As shown in FIG. 13, using the settlement processor 1305 of the present invention as a hub or conduit for sending, receiving and matching messages, the Customer and Executing Bank provide the Prime Broker with give-up details for the financial transaction (see arrows 1 and 2 in FIG. 13). The Prime Broker then sends an acceptance to the Executing Bank (arrow 3) and the matching engine 1310 provides the match status to all parties (arrows 4, 5 and 6). The Prime Broker also notifies the Customer, through the invention, that the Prime Broker has accepted the give up (arrow 7).

Upon receiving the acceptance, the Customer provides the Prime Broker with settlement details, such as a breakout of funds, accounts to use, etc. (arrow 8), which the system automatically forwards to the Account Bank on behalf of the Prime Broker (arrow 9). Next, the Account Bank sends a message confirming acceptance of the settlement details (arrow 10). Finally, the Prime Broker provides the Customer with a confirmation message confirming the settlement details and trade (arrow 11). Notably, the present invention receives and forwards all of the messages according to configurable protocols and preferences set by the parties.

Message Definitions

When it is operating as a message hub, the present invention allows a set of seven messages to be passed between four distinct entities. Below each message is described.

Give Up Messaging

Give Up Messaging is used to notify a Prime Broker of completed deals and to confirm completed deals. Multiple formats are supported to communicate the messages for the three parties.

Executing Bank Give Up Message

Header

From: Executing Bank
To: Prime Broker
Other Party: Customer
Message ID - tracks the message in the hub
Trade ID - ID used to track the life of the trade

Trade Info

Trade Date
Currency Pair

Leg Info

Leg Amount
Leg Currency
Value Date

Allocation Info

Allo Currency
Allo Amount
Account
Spot
Forward Points
All In

Customer Give Up Message

Header

From: Customer
To: Prime Broker
Other Party: Executing Bank
Message ID - tracks the message in the hub
Trade ID - ID used to track the life of the trade

Trade Info

Trade Date
Currency Pair

Leg Info

Leg Amount
Leg Currency
Value Date

Allocation Info

Allo Currency
Allo Amount

Account

Spot
Forward Points
All In

Prime Brokerage Give Up Confirm Message

Header

From: Prime Broker
To: Executing Bank
Other Party: Customer
Message ID - tracks the message in the hub
Trade ID - ID used to track the life of the trade

Content

Accept or Reject

Settlement Messaging

Settlement Messaging is used for the customer or prime broker to provide settlement account details to the appropriate account banks.

Customer Settlement Details Message

Header

From: Customer
To: Prime Broker
Other Party: Account Bank
Message ID - tracks the message in the hub
Trade ID - ID used to track the life of the trade

Settlement Details

Trade Date
Allo Currency
Allo Amount
Account

Value Date

Spot
Forward Points
All In
Settlement Instructions

Account Bank Settlement Details Notification Message

Header

From: Prime Broker
To: Account Bank
Other Party: Customer
Message ID - tracks the message in the hub
Trade ID - ID used to track the life of the trade

Settlement Details

Trade Date
Allo Currency
Allo Amount
Account
Value Date
Spot
Forward Points
All In
Settlement Instructions

Account Bank Settlement Details Confirmed Message

Header

From: Account Bank
To: Prime Broker
Other Party: None
Message ID - tracks the message in the hub
Trade ID - ID used to track the life of the trade

Content

Confirmed

Prime Brokerage Settlement Details Confirmed Message

Header

From: Prime Broker
To: Customer
Other Party: Account Bank
Message ID - tracks the message in the hub
Trade ID - ID used to track the life of the trade

Content

Confirmed

Liquidity Outsourcing

A more detailed discussion of the Liquidity Outsourcing Process is now provided.

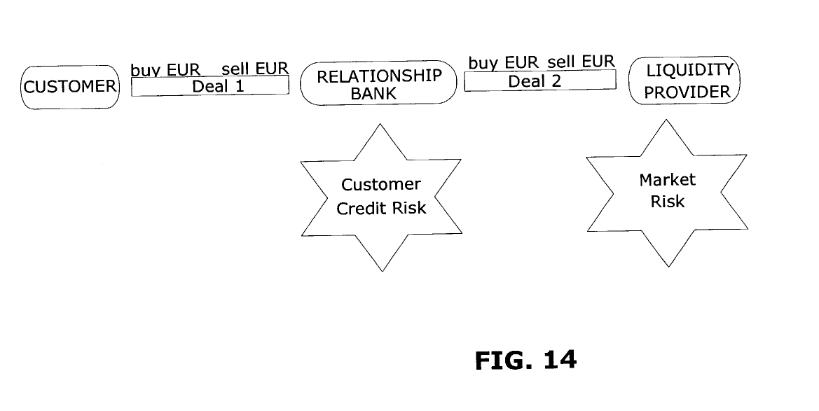

In a preferred embodiment, the liquidity outsourcing process generates at least two deals (and possibly more) for each deal executed by the customer, leaving the relationship bank with the credit risk and the liquidity provider with the market risk. As shown in FIG. 14, Deal 1 is the RFQ submitted by the customer to the relationship bank. Deal 2 is the secondary RFQ generated by FXall on behalf of the relationship bank.

In some embodiments, the dealing protocol may be implemented in a four-phase process. The four phases are:

1. Customer selects providers and submits the RFQ

2. Providers streams quotes to customer

3. Customer accepts price

4. Liquidity provider confirms the execution

An advantage of this protocol is that it ensures that execution is always atomic. In other words, either both deals are executed or neither is executed. This means there is no chance that the relationship bank will be left with one of the deals, giving it an unwanted market risk. Atomicity is guaranteed because once the customer has accepted the price (step 3), the liquidity provider has the sole right to accept or reject the execution (step 4). If the liquidity provider accepts the execution, then both deals are booked. Otherwise, neither deal is booked.

Step 1: Customer Selects Providers and Submits the RFQ

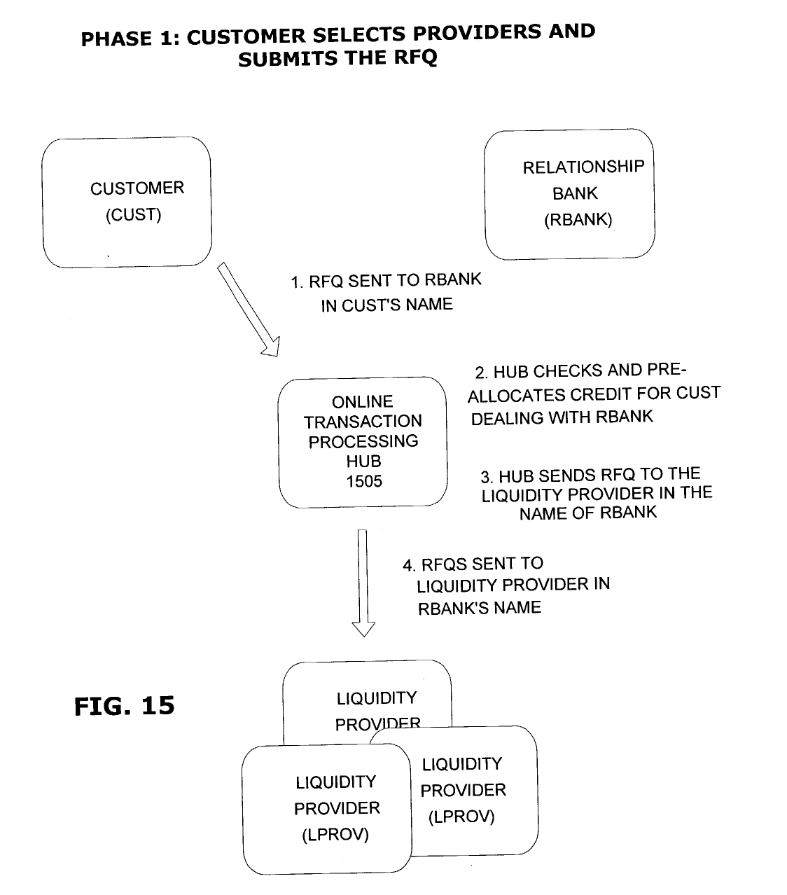

FIG. 15 shows Phase 1 in more detail. As shown in FIG. 15, in a step 1, the customer selects its relationship bank as the liquidity provider for a particular request for price quote (RFQ) and sends in an RFQ. The system, which is identified in FIG. 15 as Online Transaction Processing Hub 1505, checks and pre-allocates credit to the Customer (step 2). Next, the HUB is configured to identify one or more secondary liquidity providers capable of handling the RFQ, generate a secondary RFQ and submit the secondary RFQ to one or more potential secondary liquidity provider(s) in Rbank's name (steps 3 and 4).

Step 2: Providers Streams Quotes to Customer

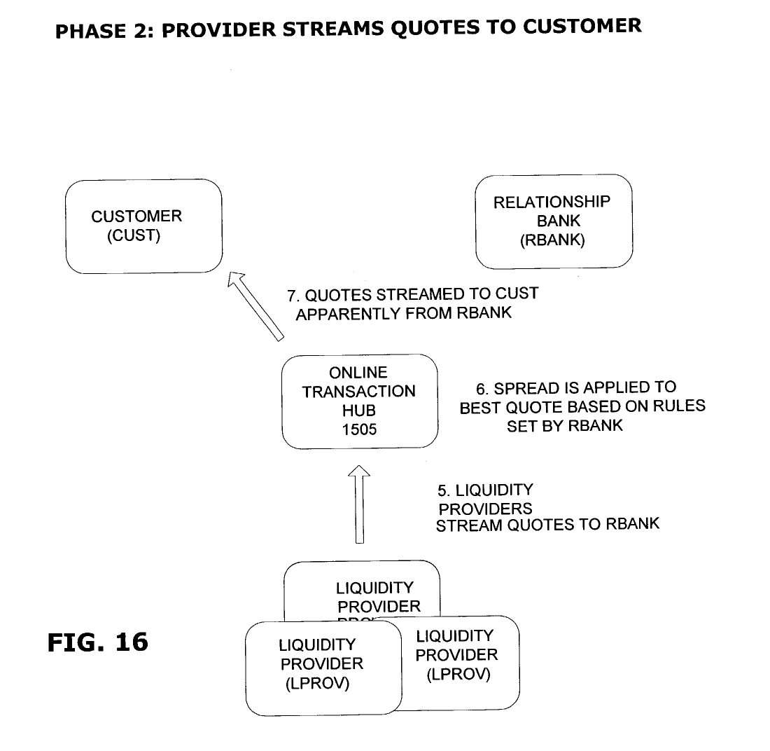

As shown in FIG. 16, the secondary liquidity providers stream their prices to Online Transaction Processing Hub 1505, preferably, although not necessarily, in real time (step 5). The Hub selects the best price and may optionally apply a spread as determined by the relationship bank (step 6). In step 7, the Hub 1505 then forwards the best prices to the customer (along with the appropriate spread in some cases). From the customer's perspective, the price stream is being sent by the relationship bank (RBANK).

Step 3: Customer Selects Price

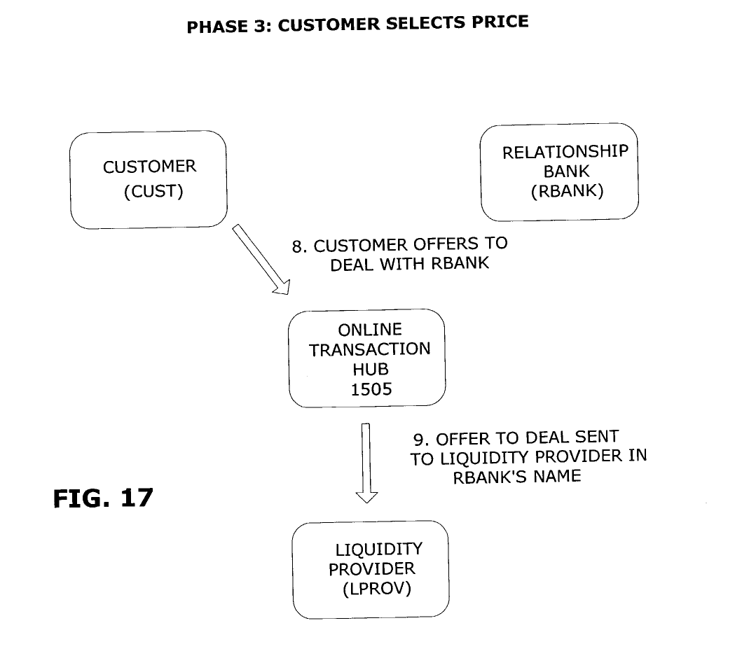

FIG. 17 illustrates the third step. The customer's Offer to Deal is then sent to the relationship bank (step 8). The Online Transaction Hub 1505 sends an Offer to Deal for the secondary RFQ to the winning secondary liquidity provider (LPROV) on behalf of the relationship bank (step 9). In some embodiments, the winning secondary liquidity provider is the one with the best price at the time the customer's offer to deal reaches the Online Transaction Hub 1505. In other embodiments, rules defined by the relationship bank will be used to select the winning liquidity provider.

Step 4: Liquidity Provider Confirms the Execution

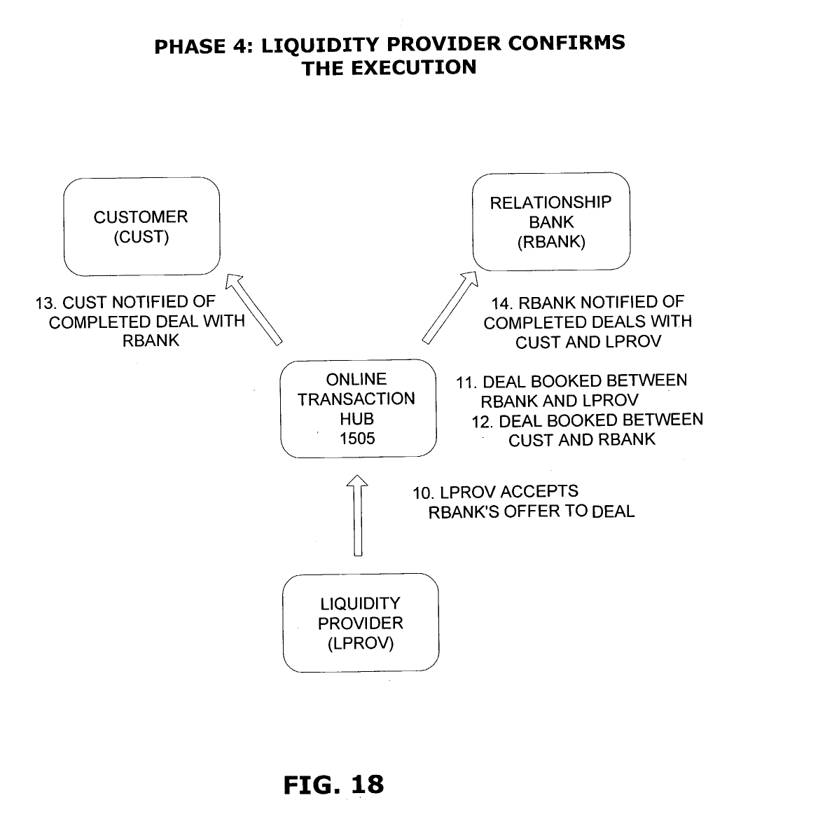

Step 4 is illustrated in FIG. 18. The deal is officially completed when the secondary liquidity provider confirms its execution with the Online Transaction Hub 1505 (illustrated in step 10). In this example, the Online Transaction Hub 1505 would book (record) two deals at this point: (1) the execution deal between the customer and the relationship bank; and (2) the deal between the relationship bank and the secondary liquidity provider (steps 11 and 12). The customer is notified that his execution with the relationship bank has been successful (step 13). The relationship bank is notified of both deals (step 14).

Outsourcing Logic

In a preferred embodiment, the invention is configured to automatically determine whether an RFQ should be outsourced, and if so, to which liquidity provider(s). When certain rules are applied, the invention provides for a very granular decision making process.

For example, the relationship bank may:

Outsource all electronic market making;

Outsource particular currencies;

Outsource particular time zones (for example, to provide customers with overnight coverage); or

Keep those deals that helped it achieve a desired market risk position.

Individual dealers at the relationship bank may also use liquidity outsourcing selectively as a backstop for incoming customer RFQs in cases where the dealers:

Are busy working a big order;

Find that the market is too volatile to service all pricing requests directly;

Want to outsource half of an FX cross;

Are away from their desks; or

Are otherwise unavailable to receive RFQs.

The ability to configure the invention to choose which liquidity providers to consider for the outsourced RFQ provides a second level of flexibility. Thus, the invention may be configured to apply a second level of rules established by the relationship bank to determine a set of potential liquidity providers for each RFQ based on certain parameters, including, but not limited to:

Target percentage of business with each liquidity provider;

Credit available with each provider;

Provider performance relative to a previously agreed service level;

Currency pair and deal size; or

Time zone.

A third level of flexibility may be achieved by configuring the invention to choose how the selected liquidity providers should be included in the RFQ. Thus, a third set of rules may be applied to provide the following facilities:

All selected providers to be included in the RFQ;

Best provider only to be included in the RFQ; or

Best provider only to be included in the RFQ, second best provider to be RFQ'd if the first provider does not respond within a certain time period.

Monitoring Liquidity Provider Performance

The set of outsourcing rules and the set of arbitration rules may be based on a variety of factors associated with the parties and the markets in general. For example, these rules may be based on a currency designation associated with the original trading request, a time zone associated with the original trading request, a credit risk associated with the customer, a market risk associated with the original trading request, a funding amount associated with the original trading request, an availability status associated with one or more providers in the set of providers, a target percentage of business associated with one or more providers in the set of providers, an available credit status for the relationship bank with one more providers in the set of providers, a performance metric or service level agreement to a service level agreement for one or more providers in the set of providers, etc. The outsourcing and arbitration rules also may be based on a combination of one or more of all of the above-listed factors.

A significant advantage of the invention is that it provides the relationship bank with tools to get the best prices for its customers and to monitor the performance and quality of the prices and services delivered by each of its liquidity providers.

One tool made available to the relationship bank by the invention, for example, is competition. By outsourcing each RFQ to two or more liquidity providers simultaneously, the providers then compete on price to win the RFQ. This requires little effort on the part of the relationship bank, but may cause the liquidity providers to focus on delivering the cheapest price at the expense of the stability of that price. Statistical monitoring by the trading platform can help in this regard by rewarding liquidity providers that focus on all pricing components. For example, the system can be configured to monitor the percentage of deal requests accepted by each bank. In the event of a price tie between liquidity providers, the bank with the highest historical acceptance rate, for example, may be selected to win the RFQ.

Another tool that can be provided with the invention is the ability to outsource each RFQ to only one provider at a time and to use statistical methods to assess the quality delivered by each bank based on, for example:

The percentage of RFQs picked up;

The price stability (frequency of price updates);

The acceptance rate when the customer offers to deal; or

The bid-offer spread quoted.

The relationship bank can analyze these statistics on a periodic basis and use the results in future negotiations with each liquidity provider. The invention may also be configured to include features for automatically rewarding the better liquidity providers by sending more RFQs to them in the future. For example, if the selected liquidity provider does not return a price within 10 seconds, the invention could be configured to automatically cancel that RFQ and automatically send a new RFQ to a backup liquidity provider. The invention may also be configured, at the option of the relationship bank, to reduce the percentage of future-business awarded to the non-respondent liquidity.

A small percentage of RFQs, say 10%, may be routed to the backup provider in the first instance. The relationship bank can then use these prices to monitor quote quality from the main liquidity provider. At periodic intervals, the percentage of RFQs routed to backup provider can be automatically changed based on the relative performance of the two providers.

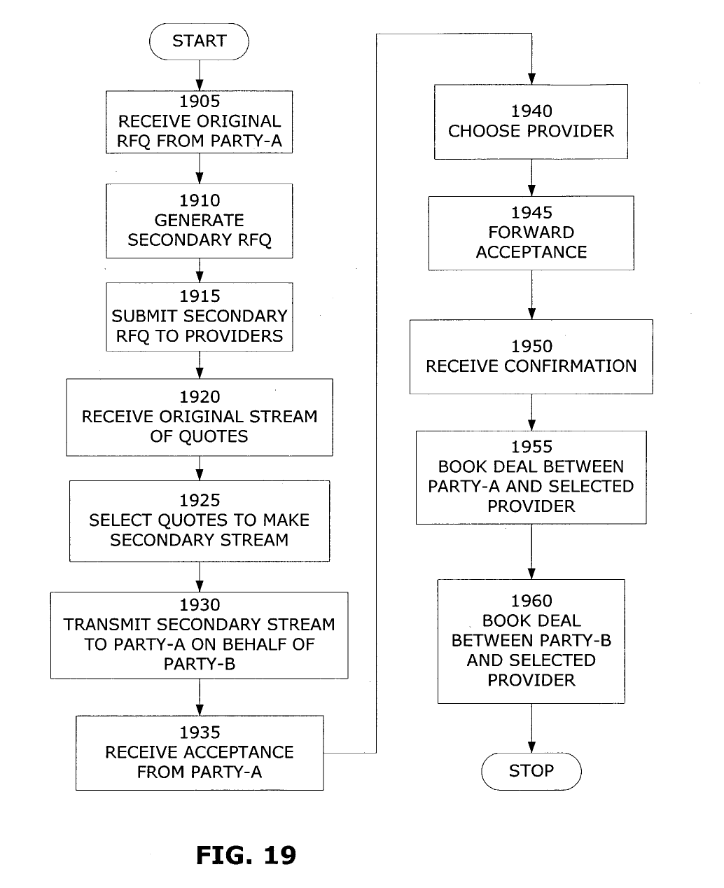

FIG. 19 contains a flow diagram illustrating the steps a processor, or a set of processors, might perform in order to implement liquidity outsourcing according to the principles of the present invention. As shown in FIG. 19, the process begins at step 1905, when the system receives an original RFQ from the Party-A (the Customer). The RFQ is directed to Party-B (the bank or other institution having a relationship with the Party-A). In a preferred embodiment, although not necessarily, the system checks Party-A's credit before forwarding the RFQ to Party-B (not shown in FIG. 19). At step 1910, the system generates a secondary RFQ based on the original RFQ received from the Party-A. Using a set of outsourcing rules provided by the Party-B, the secondary RFQ is submitted to one or more liquidity providers on behalf of the Party-B (step 1915).

Next, in step 1920, the system receives an original stream of quotes from one or more of the liquidity providers and forwards these quotes to the Party-B. The system then converts a select number of the quotes to a secondary stream of quotes (step 1925) based on the original stream of quotes received from the providers. For example, a spread may be added to the original stream of quotes to generate the secondary stream. In step 1930, the secondary stream is transmitted to the Party-A on behalf of the Party-B. If the system receives an acceptance from the Party-A responsive to the secondary stream of quotes (step 1935), a provider is selected for the transaction based on, again, rules provided by the Party-B, and the acceptance is forwarded to that provider (steps 1940 and 1945).

The system then waits to receive a confirmation or rejection from the Party-B. If a confirmation is received at step 1950, the system books a first deal between the Party-A and the liquidity provider, and a second deal between the Party-B and the liquidity provider (steps 1955 and 1960). At this point, processing ends.

The present invention has been disclosed and described herein in what is considered to be its most preferred embodiments. It should be noted that variations and equivalents may occur to those skilled in the art upon reading the present disclosure and that such variations and equivalents are intended to come within the scope of the invention and the appended claims. Therefore, for example, it should be understood by one skilled in the art that the present invention is not limited to foreign exchange transactions, and may be beneficially applied to other types of transactions as described above.

What is claimed is:

1. A computer system for processing a previously-executed financial transaction, comprising:
an interface to a data communications network;
a message database;
a settlement processor, coupled to said interface, configured
to establish an online connection to a remote computer via the data communications network,
to receive from the remote computer, via the online connection, an incoming message containing a set of details pertaining to the previously-executed financial transaction, and
to store the incoming message in said message database; and
a matching subsystem configured
to retrieve said incoming message from said database, and
to determine whether a match exists between the set of details in the incoming message and a second set of details in a second message stored in said database;
wherein, if the match exists, the settlement processor is further configured to book the previously-executed financial transaction.

2. The computer system of claim 1, wherein the settlement processor is further configured to provide a match status to the remote computer via said online connection prior to booking the previously-executed financial transaction.

3. The computer system of claim 1, further comprising:
a deal execution-stage processor configured
to receive, via another online connection, an original request to participate in the previously-executed financial transaction, and
to provisionally book the previously-executed financial transaction prior to the matching subsystem determining whether the match exists.

4. The computer system of claim 1, wherein
said set of details comprises a field identifying a counterparty for the previously-executed financial transaction; and
said settlement processor is further configured
to establish a second online connection to the counterparty, and
to avoid booking the previously-executed financial transaction until said settlement processor has received a confirmation from the counterparty via said second online connection.

5. The computer system of claim 1, wherein
the settlement processor is further configured
to generate an outgoing message pertaining to the previously-executed financial transaction, said outgoing message comprising a notification that the previously-executed financial transaction has been booked, and
to transmit the outgoing message to the remote computer via the data communications network.

6. The computer system of claim 5, further comprising an adapter program, configured to execute on the remote computer in cooperation with said settlement processor, said adapter program being further configured
to receive the incoming message from a user application running on the remote computer, and
to transmit the incoming message from said remote computer to said settlement processor via said data communications network.

7. The computer system of claim 6, wherein the adapter program is further configured to translate the incoming message into a format compatible with the settlement processor.

8. The computer system of claim 6, wherein the adapter program is further configured
to receive the outgoing message from said settlement processor via said data communications network, and
to send said outgoing message to the user application.

9. The computer system of claim 8, wherein the adapter program is further configured to translate the outgoing message into a format compatible with the user application.

10. The computer system of claim 1, wherein the matching subsystem comprises:
a workflow processor; and
a matching engine configured to compare the set of details to the second set of details under the control of the workflow processor.

11. The computer system of claim 1, wherein the settlement processor comprises:
a session manager configured to control the online connection; and
a user interface manager configured to control data communications with the remote computer.

12. The computer system of claim 11, wherein the user interface manager is further configured to control data communications with an adapter program running on the remote computer.

13. The computer system of claim 1, wherein said settlement processor is further configured to translate the incoming message into a format compatible with said matching subsystem prior to storing the incoming message in said message database.

14. The computer system of claim 13, wherein the format is the SWIFT MT300 format.

15. The computer system of claim 1, wherein the data communications network is the Internet.

16. The computer system of claim 1, wherein the data communications network is the SWIFT network.

17. The computer system of claim 1, wherein the data communications network is a virtual private network.

18. A computer-aided method for settling a previously-executed financial transaction, comprising:
receiving from a Party-A a Party-A-perspective set of details for the previously-executed financial transaction;
receiving from a Party-B a Party-B-perspective set of details for the previously-executed financial transaction;
determining whether the Party-A-perspective set of details matches the Party-B-perspective set of details;
establishing an online connection for the Party-A via a data communications network, said online connection being configured to convey information pertaining to the previously-executed financial transaction to the Party-A;
transmitting the Party-A-perspective set of details and the Party-B-perspective set of details to the Party-A via said online connection; and
if there is a match between the Party-A-perspective set of details and the Party-B-perspective set of details, booking the previously-executed financial transaction.

19. The method of claim 18, further comprising the step of providing a match status to the Party-A via said online connection prior to said step of booking the previously-executed financial transaction.

20. The method of claim 18, further comprising the step of:
receiving, via another online connection, an original request from the A Party to participate in the previously-executed financial transaction with the Party-B, and
to provisionally book the previously-executed financial transaction prior to the step of determining whether the match exists.

21. The method of claim 18, further comprising:
establishing a second online connection for the Party-B, said second online connection being configured to convey information pertaining to the previously-executed financial transaction to the Party-B;
transmitting the Party-A-perspective set of details and the Party-B-perspective set of details to the Party-B via said second online connection; and
providing a match status to the Party-B via said second online connection.

22. The method of claim 19, further comprising the steps of:
receiving a processing directive from the Party-A responsive to said match status via said online connection;
receiving a confirmation for said processing directive from the Party-B via said second online connection; and
responsive to said processing directive and said confirmation, booking the previously-executed financial transaction.

23. The method of claim 18, wherein the previously-executed financial transaction comprises a foreign exchange transaction.

24. The method of claim 18, wherein each of said receiving steps comprises receiving a SWIFT MT300 confirmation message.

25. The method of claim 18, wherein the Party-A-perspective set of details comprises a set of economic details for the previously-executed financial transaction.

26. The method of claim 25, wherein the Party-B-perspective set of details comprises a set of economic details for the previously-executed financial transaction.

27. The method of claim 18, wherein the Party-A-perspective set of details comprises an account identifier for the previously-executed financial transaction.

28. The method of claim 27, wherein the Party-B-perspective set of details comprises an account identifier for the previously-executed financial transaction.

29. The method of claim 18, wherein the Party-A-perspective set of details comprises a counterparty identifier for the previously-executed financial transaction.

30. The method of claim 29, wherein the Party-B-perspective set of details comprises a counterparty identifier for the previously-executed financial transaction.

31. The method of claim 18, wherein the previously-executed financial transaction is initiated via a computerized online financial transaction network.

32. The method of claim 31, wherein the computerized online financial transaction network comprises a foreign exchange trading portal.

33. The method of claim 18, wherein the previously-executed financial transaction is initiated via a public switched telephone network (PSTN).

34. The method of claim 18, wherein the previously-executed financial transaction is initiated via a face-to-face meeting between Party-A and Party-B.

35. The method of claim 18, wherein each of said receiving steps comprises storing a set of details for the previously-executed financial transaction in a database.

36. A computer-aided method for processing a plurality of previously-executed financial transactions, comprising:
receiving an incoming message associated with a previously-executed financial transaction in the plurality of previously-executed financial transactions, said previously-executed financial transaction involving a Party-A and a Party-B;
determining whether the incoming message comprises a set of details matching a second set of details contained in a message previously-received from the Party-A or the Party-B;
establishing an online connection with the Party-A, said online connection being configured to convey information pertaining to the previously-executed financial transaction to the Party-A;
transmitting said set of details and said second set of details to the Party-A via said online connection; and
if there is a match between said set of details and said second set of details, booking the previously-executed financial transaction.

37. The method of claim 36, further comprising the step of providing a match status to the Party-A via said online connection prior to said step of booking the previously-executed financial transaction.

38. The method of claim 36, further comprising the step of provisionally booking the previously-executed financial transaction prior to said step of determining whether the match exists.

39. The method of claim 36, wherein said booking step comprises the steps of:
establishing a second online connection for the Party-B, said second online connection being configured to convey information pertaining to the previously-executed financial transaction to the Party-B;
receiving from the Party-A, via said online connection, a processing directive responsive to the match status;
transmitting the processing directive to the Party-B via said second online connection; and
receiving from the Party-B, via said second online connection, a confirmation responsive to the processing directive.

40. The method of claim 39, wherein said processing directive comprises at least one of the following:
a directive to break said match,
a directive to create a forced match between said set of details and said second set of details,
a directive to create a new message containing a third set of details, wherein said third set of details matches said set of details,
a directive to cancel the incoming message,
a directive to send a notice pertaining to the incoming message to the Party-B,
a directive to send a notice pertaining to the incoming message to a Party-C,
a directive to remove the incoming message from a message matching queue, and
a directive to mark the incoming message for deferral.

41. The method of claim 36, wherein said receiving step comprises storing the incoming message in a message database.

42. The method of claim 36, wherein said receiving step comprises determining whether said incoming message comprises an amendment request for a message previously received from the Party-A.

43. The method of claim 36, wherein said receiving step comprises determining whether said incoming message comprises a cancellation request for a message previously received from the Party-A.

44. The method of claim 36, further comprising the step of determining whether said incoming message comprises a set of settlement instructions.

45. The method of claim 44, further comprising the step of adding a set of settlement instructions to the incoming message.

46. The method of claim 36, wherein said receiving step comprises placing the incoming message in a message matching queue.

47. The method of claim 36, wherein said receiving step comprises sending a notification to the Party-B indicating that said incoming message has been received.

48. The method of claim 36, wherein said receiving step comprises sending a notification to a Party-C indicating that said incoming message has been received.

49. The method of claim 36, further comprising the step of converting the incoming message to SWIFT MT300 format.

50. The method of claim 36, wherein said determining step comprises assigning a message state to the incoming message.

51. The method of claim 36, wherein said determining step comprises assigning a match status to the incoming message.

52. The method of claim 36, wherein said determining step comprises sending a notification to the Party-B indicating that said second set of details has been matched.

53. The method of claim 36, wherein said determining step comprises sending a notification to a Party-C indicating that said second set of details has been matched.

54. The method of claim 36, further comprising the step of receiving a settlement instruction election from the Party-A via said online connection.

55. The method of claim 54, wherein said settlement instruction election comprises a request to use a pre-defined set of settlement instructions.

56. The method of claim 54, wherein said settlement instruction election comprises a request to use a new set of settlement instructions.

57. The method of claim 54, wherein said settlement instruction election comprises a request to modify a pre-defined set of settlement instructions.

58. The method of claim 36, further comprising the step of presenting a set of netted settlement payments to the Party-A for the plurality of previously-executed financial transactions.

59. The method of claim 58, wherein said presenting step comprises:
receiving, from the Party-A via said online connection, a selected value date and a selected combination of accounts and counterparties for a subset of previously-executed financial transactions in the plurality of previously-executed financial transactions;
calculating the set of netted payments for the subset of previously-executed financial transactions based on the selected value dates and the selected combinations; and
transmitting the set of netted payments to the Party-A via said online connection.

60. The method of claim 59, further comprising the step of transmitting the set of netted payments to each counterparty in the selected combination for approval.

61. The method of claim 59, wherein the calculating step is carried out using a specified netting mode.

62. The method of claim 61, wherein the netting mode requires producing a netted payment for each currency pair in the subset of previously-executed financial transactions.

63. The method of claim 61, wherein the netting mode requires producing a netted payment for each currency in the subset of previously-executed financial transactions.

64. The method of claim 61, wherein the netting mode requires producing a set of netted payments to be paid directly between two or more counterparties other than the Party-A to reduce a number of settlement payments to be paid by the Party-A.

65. The method of claim 59, further comprising the step of receiving from the Party-A a settlement instruction for each netted payment in the set of netted payments.

66. The method of claim 36, wherein the previously-executed financial transaction comprises a foreign exchange transaction.

67. The method of claim 36, wherein said receiving step comprises receiving a SWIFT MT300 confirmation message.

68. The method of claim 36, wherein said set of details comprises a set of economic details for the previously-executed financial transaction.

69. The method of claim 36, wherein said set of details comprises an account identifier for the previously-executed financial transaction.

70. The method of claim 36, wherein said set of details comprises a counterparty identifier for the previously-executed financial transaction.

71. The method of claim 36, wherein the previously-executed financial transaction is initiated via a computerized online financial transaction network.

72. The method of claim 71, wherein the computerized online financial transaction network comprises a foreign exchange trading portal.

73. The method of claim 36, wherein the previously-executed financial transaction is initiated via a public switched telephone network (PSTN).

74. The method of claim 36, wherein the previously-executed financial transaction is initiated via a face-to-face meeting.

75. A computer system for processing financial transactions, comprising:
a settlement server program; and
a matching subsystem, operating under control of said settlement server program, configured to generate a match status for two sets of financial transaction details pertaining to a previously-executed financial transaction;
wherein the settlement server program is configured
to transmit the two sets of transaction details and the match status to a broker client program via a first data communications channel, and
to accept from the broker client program a processing directive responsive to the match status,
to transmit the processing directive to a provider client program via a second data communications channel and a customer client program via a third communications channel, and
responsive to the input, to book the previously-executed financial transaction.

76. The computer system of claim 75, wherein the processing directive comprises at least one of:
a request to change the previously-executed financial transaction,
a request to modify a settlement date for the previously-executed financial transaction,
a request to modify a rate associated with the previously-executed financial transaction,
a request to use a specified account to settle the previously-executed financial transaction,
a request to split the previously-executed transaction into multiple financial transactions,
a request to force a match between the two two sets of financial transaction details,
a request to break a match between the two sets of financial transaction details,
a request to create a match between the two sets of financial transaction details, and
a request to transmit a notice regarding one or more details in the two sets of transaction details.

77. A computer system for processing a previously-executed financial transaction involving a Party-A and a Party-B, comprising:
an interface to a data communications network;
a settlement processor, coupled to said interface, configured
to establish a first online connection for the Party-A via the data communications network,
to establish a second online connection for the Party-B via the data communications network,
to receive from the Party-A, via the first online connection, a set of Party-A give-up details pertaining to a first financial transaction between the Party-A and a Party-C, and
to receive from the Party-B, via the second online connection, a set of Party-B give-up details pertaining to a second financial transaction between the Party-B and the Party-C; and
a matching subsystem configured to determine whether a match exists between the Party-A give-up details and the Party-B give-up details;
wherein, if the match exists, the settlement processor is further configured
to book the first financial transaction between the Party-A and the Party-C, and
to book the second financial transaction between the Party-B and the Party-C.

78. The computer system of claim 77, wherein the settlement processor is further configured to provide a match status to the Party-A via said first online connection prior to booking the first financial transaction.

79. The computer system of claim 77, wherein the settlement processor is further configured to provide a match status to the Party-B via said first online connection prior to booking the second financial transaction.

80. The computer system of claim 77, further comprising:
a deal execution-stage processor configured
to receive, via another online connection, an original request from the Party-A to participate in the previously-executed financial transaction with the Party-B,
to provisionally book the first financial transaction prior to the matching subsystem determining whether the match exists, and
to provisionally book the second financial transaction prior to the matching subsystem determining whether the match exists.

81. The computer system of claim 80, wherein
the original request from the Party-A to participate in the previously-executed financial transaction with the Party-B is based on an arrangement between the Party-A and the Party-C; and
prior to transmitting the original request to the Party-B, said deal execution-stage processor confirms whether said arrangement authorizes the Party-A to make said original request.

82. The computer system of claim 81, wherein the arrangement comprises at least one of:
a credit limit,
a currency pair restriction,
a forward date limitation,
a requirement to use a specified account,
an execution date restriction, and
a settlement date restriction.

83. The computer system of claim 77, wherein said settlement processor is further configured
to establish a third online connection for the Party-C;
to transmit the Party-A give-up details to the Party-C on behalf of the Party-A; and
to transmit the Party-B give-up details to the Party-C on behalf of the Party-B.

84. The computer system of claim 83, wherein the settlement processor is further configured to transmit a notification to the Party-A that the Party-A give-up details have been transmitted to the Party-C.

85. The computer system of claim 83, wherein the settlement processor is further configured to transmit a notification to the Party-B that the Party-B give-up details have been transmitted to the Party-C.

86. The computer system of claim 83, wherein the settlement processor is further configured
to receive a Party-C give-up acceptance from the Party-C responsive to the transmission to the Party-C of the Party-A give-up details and the Party-B give-up details; and
to transmit the Party-C give-up acceptance to the Party-A and the Party-B on behalf of the Party-C.

87. The computer system of claim 77, wherein the first financial transaction is booked at a higher rate than the second financial transaction.

88. The computer system of claim 77, wherein the settlement processor is further configured to transmit a notification to the Party-A and to the Party-B that the first and second financial transactions have been booked.

89. The computer system of claim 77, wherein
the settlement processor is further configured
to receive from the Party-A, via the first online connection, a set of Party-A details pertaining to a third financial transaction between the Party-A and the Party-B, wherein said third financial transaction comprises a portion of the previously-executed financial transaction not given up to the Party-C, and
to receive from the Party-B, via the second online connection, a set of Party-B details pertaining to the third financial transaction; and
a matching subsystem further configured to determine whether a second match exists between the Party-A details and the Party-B details;
wherein, if the second match exists, the settlement processor is further configured to book the third financial transaction.

90. The computer system of claim 89, wherein the settlement processor is further configured to provide a match status for the Party-A details and the Party-B details to the Party-A via said first online connection prior to booking the third financial transaction.

91. The computer system of claim 89, wherein the settlement processor is further configured to provide a match status for the Party-A details and the Party-B details to the Party-B via said second online connection prior to booking the third financial transaction.

92. The computer system of claim 89, wherein the settlement processor is further configured to transmit a notification to the Party-A and to the Party-B that the third financial transaction has been booked.

93. The computer system of claim 89, further comprising:
a deal execution-stage processor configured
to receive, via another online connection, an original request from a Party-A to participate in the third financial transaction with the Party-B, and
to provisionally book the third financial transaction prior to the matching subsystem determining whether the second match exists.

94. The computer system of claim 77, wherein the settlement processor is further configured
to receive from the Party-C a set of settlement details based on a fund allocation provided to the Party-C by the Party-A; and
to establish a fourth online connection for a Party-D, and
to transmit the set of settlement details to the Party-D via said fourth online connection.

95. The computer system of claim 94, wherein said set of settlement details comprises data representative of one or more of:
a funding account,
a funding amount, and
a value date.

96. The computer system of claim 94, wherein the settlement processor is further configured
to receive from the Party-D a Party-D settlement confirmation message responsive to the set of settlement details;
to transmit said Party-D settlement confirmation message to the Party-C on behalf of the Party-D;
to receive from the Party-C a Party-C confirmation message responsive to said Party-D settlement confirmation message; and
to transmit said Party-C settlement confirmation message to the Party-A.

97. The computer system of claim 96, wherein said matching subsystem is further configured to determine whether there is a match between the Party-C settlement confirmation message and the set of settlement details.

98. The computer system of claim 77, further comprising an adapter program, configured to execute on a remote computer operated by the Party-A and in cooperation with said settlement processor, said adapter program being further configured
to receive a Party-A give-up message containing the Party-A give-up details from a user application running on the remote computer, and
to transmit the Party-A give-up message from said remote computer to said settlement processor via said data communications network.

99. The computer system of claim 98, wherein the adapter program is further configured to translate the Party-A give-up message into a format compatible with the matching subsystem.

100. The computer system of claim 98, further comprising an adapter program, configured to execute on a remote computer operated by the Party-B and in cooperation with said settlement processor, said adapter program being further configured
to receive a Party-B give-up message from a user application running on the remote computer, and
to transmit the Party-B give-up message from said remote computer to said settlement processor via said data communications network.

101. The computer system of claim 100, wherein the adapter program is further configured to translate the Party-B give-up message into a format compatible with the matching subsystem.

102. The computer system of claim 77, wherein the matching subsystem comprises:
a workflow processor; and
a matching engine configured to compare the first set of details to the second set of details under the control of the workflow processor.

103. The computer system of claim 77, wherein the settlement processor comprises:
a session manager configured to control the online connection; and
a user interface manager configured to control data communications over the data communications network with the Party-A, the Party-B, the Party-C or the Party-D.

104. The computer system of claim 103, wherein the user interface manager is further configured to control data communications with an adapter program running on a remote computer operated by the Party-A or the Party-B.

105. The computer system of claim 103, further comprising a message database configured to store the first and second incoming messages.

106. The computer system of claim 105, wherein said settlement processor is further configured to store the Party-A give up details and Party-B give-up details in said message database.

107. The computer system of claim 77, wherein the data communications network is the Internet.

108. The computer system of claim 77, wherein the data communications network is the SWIFT network.

109. The computer system of claim 77, wherein the data communications network is a virtual private network.

110. A computer-aided method for processing a previously-executed financial transaction involving a Party-A and a Party-B, comprising the steps of:
establishing a first online connection for the Party-A via a data communications network,
establishing a second online connection for the Party-B via the data communications network,
receiving from the Party-A, via the first online connection, a set of Party-A give-up details pertaining to a first financial transaction between the Party-A and a Party-C, and
receiving from the Party-B, via the second online connection, a set of Party-B give-up details pertaining to a second financial transaction between the Party-B and the Party-C;
determining whether a match exists between the Party-A give-up details and the Party-B give-up details; and
if the match exists,
booking the first financial transaction between the Party-A and the Party-C, and
booking the second financial transaction between the Party-B and the Party-C.

111. The method of claim 110, further comprising the step of providing a match status to the Party-A via said first online connection prior booking the previously-executed financial transaction.

112. The method of claim 110, further comprising the steps of:
receiving, via another online connection, an original request from the Party-A to participate in the previously-executed financial transaction with the Party-B;
provisionally booking the first financial transaction prior to the matching subsystem determining whether the match exists; and
provisionally booking the second financial transaction prior to the matching subsystem determining whether the match exists.

113. The method of claim 112, further comprising the step of:
prior to transmitting the original request to the Party-B, confirming whether an arrangement between the Party-A and the Party-C authorizes the Party-A to make said original request

114. The method of claim 113, wherein the arrangement comprises at least one of:
a credit limit,
a currency pair restriction,
a forward date limitation,
a requirement to use a specified account,
an execution date restriction, and
a settlement date restriction.

115. The method of claim 110, further comprising the steps of:
establishing a third online connection for the Party-C;
transmitting the Party-A give-up details to the Party-C on behalf of the Party-A; and
transmitting the Party-B give-up details to the Party-C on behalf of the Party-B.

116. The method of claim 115, further comprising the step of transmitting a notification to the Party-A that the Party-A give-up details have been transmitted to the Party-C.

117. The method of claim 115, further comprising the step of transmitting a notification to the Party-B that the Party-B give-up details have been transmitted to the Party-C.

118. The method of claim 115, further comprising
receiving a Party-C give-up acceptance from the Party-C responsive to the transmission to the Party-C of the Party-A give-up details and the Party-B give-up details; and
transmitting the Party-C give-up acceptance to the Party-A and the Party-B on behalf of the Party-C.

119. The method of claim 115, wherein the step of booking the first financial transaction comprises booking the first financial transaction at a higher rate than the second financial transaction.

120. The method of claim 115, further comprising the step of sending a notification to the Party-A and to the Party-B that the first and second financial transactions have been booked.

121. The method of claim 115, further comprising the steps of:
receiving from the Party-A, via the first online connection, a set of Party-A details pertaining to a third financial transaction between the Party-A and the Party-B, wherein said third financial transaction comprises a portion of the previously-executed financial transaction not given up to the Party-C, and
receiving from the Party-B, via the second online connection, a set of Party-B details pertaining to the third financial transaction;
determining whether a second match exists between the Party-A details and the Party-B details; and
if the second match exists, booking the third financial transaction.

122. The method of claim 121, further comprising the step of providing a match status for the Party-A details and the Party-B details to the Party-A via said first online connection prior booking the third financial transaction.

123. The method of claim 121, wherein the settlement processor is further configured to provide a match status for the Party-A details and the Party-B details to the Party-B via said second online connection prior booking the third financial transaction.

124. The method of claim 121, further comprising the step of sending a notification to the Party-A and to the Party-B that the third financial transaction has been booked.

125. The method of claim 121, further comprising:
receiving, via another online connection, an original request from a Party-A to participate in the third financial transaction with the Party-B, and
provisionally booking the third financial transaction prior to determining whether the second match exists.

126. The method of claim 110, further comprising the steps of:
receiving from the Party-C a set of settlement details based on a fund allocation provided to the Party-C by the Party-A;
establishing a fourth online connection for a Party-D; and
transmitting the set of settlement details to the Party-D via said fourth online connection.

127. The method of claim 126, wherein said set of settlement details comprises data representative of one or more of:
a funding account,
a funding amount, and
a value date.

128. The method of claim 126, further comprising the steps of:
receiving from the Party-D a Party-D settlement confirmation message responsive to the set of settlement details;
transmitting said Party-D settlement confirmation message to the Party-C on behalf of the Party-D;
receiving from the Party-C a Party-C confirmation message responsive to said Party-D settlement confirmation message; and
transmitting said Party-C settlement confirmation message to the Party-A.

129. The method of claim 128, further comprising the step of determining whether there is a match between the Party-C settlement confirmation message and the set of settlement details.

130. A computer-aided method for processing financial transactions, comprising the steps of:
receiving an original trading request for an original transaction from a Party-A, said original trading request being directed to a Party-B;
generating a secondary trading request based on the original trading request;
submitting said secondary trading request to a set of providers on behalf of the Party-B, said set of providers being selected based on a set of outsourcing rules;
receiving from a subset of said set of providers an original stream of responses responsive to the secondary trading request;
selecting one or more responses from the original stream of responses to form a secondary stream of responses;
transmitting said secondary stream of responses to the Party-A on behalf of the Party-B; and
receiving an acceptance from the Party-A responsive to the secondary stream of responses; and
responsive to the acceptance,
choosing a selected provider based on said original stream of responses and a set of arbitration rules,
forwarding the acceptance to the selected provider on behalf of the Party-B,
receiving a confirmation from the selected provider responsive to said acceptance, and
substantially simultaneously with receiving said confirmation, booking a pair of financial transactions based on the original financial transaction;
wherein the pair of financial transactions comprises a first financial transaction between the Party-A and the selected provider and a second financial transaction between the Party-B and the selected provider.

131. The method of claim 130, wherein
the original trading request comprises a request for quotes; and
the stream of responses comprises a stream of price quotes

132. The method of claim 130, wherein the original financial transaction is a foreign exchange transaction.

133. The method of claim 130, wherein said subset of providers and said set of providers are the same.

134. The method of claim 130, further comprising the step of receiving the set of outsourcing rules from the Party-B.

135. The method of claim 130, further comprising the step of receiving the set of arbitration rules from the Party-B.

136. The method of claim 130, wherein the steps of receiving the confirmation and booking the pair of financial transactions on a real time basis.

137. The method of claim 130, further comprising the step of adding a spread to said one or more responses selected from the original stream of responses.

138. The method of claim 130, wherein the set of outsourcing rules is based on one or more of the following:
a currency designation associated with the original trading request,
a time zone associated with the original trading request,
a credit risk associated with the Party-A,
a market risk associated with the original trading request,
a funding amount associated with the original trading request,
an availability status associated with one or more providers in said set of providers,
a target percentage of business associated with one or more providers in the set of providers,
an available credit status for the Party-B with one or more providers in the set of providers,
a service level agreement for one or more providers in the set of providers, and
a performance metric for one or more providers in the set of providers.

139. The method of claim 130, further comprising the steps of:
tracking a set of performance metrics for each liquidity provider in the set of providers to form a historical performance record for said set of providers; and
automatically adjusting said set of arbitration rules based on the historical performance record.

140. The method of claim 139, wherein the set of performance metrics comprises one or more of the following:
a number of confirmations received,
an average response time,
an average price differential,
an average price stability rating,
an average bid-offer spread,
a percentile ranking of providers, and
a percentage of acceptances confirmed.

141. The method of claim 130, further comprising the step of submitting said secondary trading request to a second set of providers.

142. A computer system for processing financial transactions, comprising the steps of:
means for receiving an original trading request from a Party-A, said original trading request being directed to a Party-B;
means for generating a secondary trading request based on said original request receiving means;
means for submitting said secondary trading request to a set of providers on behalf of the Party-B, said set of providers being selected based on a set of outsourcing rules;
means for receiving from a subset of said set of providers an original stream of responses responsive to the secondary trading request;
means for selecting one or more responses from the original stream of responses to form a secondary stream of responses;
means for transmitting said secondary stream of responses to the Party-A on behalf of the Party-B; and
means for receiving an acceptance from the Party-A responsive to the secondary stream of responses; and
means, responsive to the acceptance, for
choosing a selected provider based on said original stream of responses and a set of arbitration rules,
forwarding the acceptance to the selected provider on behalf of the Party-B,
receiving a confirmation from the selected provider responsive to said acceptance, and
substantially simultaneously with receiving said confirmation, booking a pair of financial transactions based on the original financial transaction;
wherein the pair of financial transactions comprises a first financial transaction between the Party-A and the selected provider and a second financial transaction between the Party-B and the selected provider.

143. The computer system of claim 142, wherein the set of outsourcing rules is specified by the Party-B.

144. The computer system of claim 142, wherein the set of arbitration rules is specified by the Party-B.

145. The computer system of claim 142, wherein the means for receiving the confirmation and booking the pair of financial transactions operate on a real time basis.

146. The computer system of claim 142, further comprising means for adding a spread to said one or more responses selected from the original stream of responses.

147. The computer system of claim 142, wherein the set of outsourcing rules is based on one or more of the following:
a currency designation associated with the original trading request,
a time zone associated with the original trading request,
a credit risk associated with the Party-A,
a market risk associated with the original trading request,
a funding amount associated with the original trading request,
an availability status associated with one or more providers in said set of providers,
a target percentage of business associated with one or more providers in the set of providers,
an available credit status for the Party-B with one more providers in the set of providers,
a service level agreement for one or more providers in the set of providers, and
a performance metric for one or more providers in the set of providers.

148. The computer system of claim 142, further comprising:
means for tracking a set of performance metrics for each liquidity provider in the set of providers to form a historical performance record for said set of providers; and
means for automatically adjusting said set of arbitration rules based on the historical performance record.

149. The computer system of claim 148, wherein the set of performance metrics comprises one or more of the following:
a number of confirmations received,
an average response time,
an average price differential,
an average price stability rating,
an average bid-offer spread,
a percentile ranking of providers, and
a percentage of acceptances confirmed.

150. The computer system of claim 142, further comprising a credit engine configured to provide credit information about the Party-A prior to submitting the trading request to the Party-B.

151. The computer system of claim 142, wherein said means for choosing a selected provider comprises a relationship router.

152. The computer system of claim 142, wherein said means for submitting said secondary trading request comprises a relationship router.
